(19) United States
(12) Patent Application Publication
(10) Pub. No.: US 2021/0001465 A1
(43) Pub. Date: Jan. 7, 2021

(54) ECCENTRIC MECHANISM AND POWER TOOL PROVIDED WITH THE ECCENTRIC MECHANISM

(71) Applicant: Griot's Garage, Inc., Tacoma, WA (US)

(72) Inventors: Jeffrey L. Brown, Tacoma, WA (US); Gangyi Shen, Yongkang City (CN); Yingjie Chen, Yongkang City (CN)

(21) Appl. No.: 16/913,670

(22) Filed: Jun. 26, 2020

(30) Foreign Application Priority Data
Jul. 4, 2019 (CN) 201930354675.X

(51) Int. Cl. B25F 5/00; B25F 5/02

(52) U.S. Cl. CPC B25F 5/008; B25F 5/006; B25F 5/02

(57) ABSTRACT

A power tool for use with a rotatable work element, having a housing with sidewall apertures, a motor located within the housing and operable to rotate a work element drive member, a central support member and an annular fan member. The central support member having an outer perimeter support wall portion with a fan member perimeter portion attached, each section of the fan member perimeter portion including a fan blade and a fan member aperture adjacent to the fan blade to direct air from within the housing through the fan member aperture toward the housing sidewall apertures. An eccentric member is mounted on the central support member for rotation therewith, and a counterweight is mounted on the central support member for rotation therewith.

### TECHNICAL FIELD

The present invention relates to the field of tools and in particular to eccentric mechanisms and power tools.

### BACKGROUND TECHNIQUE

Power tools, as hardware tools, such as grinding or polishing machines, are indispensable tools in human life. The power tool is a tool that works by electrically driving a motor. The inside of the housing contains heat-generating components, such as drivers or electronic components, and grinders or polishers are driven by drivers and also generate heat. When the heat is concentrated in the outer housing or when the grinder or polisher has been running continuously or for a long period of time, the generated heat must be dissipated. On the one hand, this guarantees the continuous or long-term use of the tool, and on the other hand, it is the most important aspect and can guarantee the service life.

In the prior art device, as shown in FIGS. 1 and 2, the existing power tool has no heat-dissipating mechanism on the working unit, and the working unit is directly connected to the driving unit through the eccentric structure. During the long-term or continuous rotation of the working unit, the working unit will generate heat, and the working unit and the whole of the power tool will increase in temperature, especially if the working unit is directly used for grinding or polishing. If heat is not released well, on the one hand, it will have a great impact on the power tool, greatly reducing the service life. On the other hand, the heat of the working unit will be transferred to a surface, such as a polished surface, such as that of a car, and may cause damage to a medium, such as the surface of a car, that requires grinding or polishing.

DE102007000290A1 discloses that air is provided or directed by an air guiding element defining a second air flow passage through which at least one portion of the non-oriented primary air flow can be delivered to the electronic component. In such conditions, the electronic component is provided within the end of the handle housing portion. The electronic component is remote from the driver housing portion. The airflow is drawn into the housing by a fan device of the power tool through a plurality of housing slots and then flows along the main airflow path to the fan device, the primary airflow passage being defined by the structural portion of the driver housing. The air guiding element is provided substantially perpendicular to the direction of the primary airflow along the drive motor and directs the second airflow into the outer housing of the handle portion, the outer housing being provided substantially perpendicular to the outer housing of the driver. In the prior art device, although a solution to the problem of heat dissipation of a power tool is provided to a certain extent, since the air guiding element is provided externally, where the intake air is dissipated, it may also potentially suck dust particles or the like through the air inlet, which may damage the power tool or at least negatively affect the service life of the power tool.

### SUMMARY OF THE INVENTION

The present invention is directed to the deficiencies in the prior art, and provides a power tool provided with a heat-dissipating mechanism to dissipate heat from the power tool, especially to dissipate heat from working components, such as a grinding head and a polishing head and components, thereby greatly improving the service life of the tool, accessories, and better protecting products, such as the surface medium of automobiles, preventing degradation of finish.

In order to solve the above technical problems, the present invention is solved by the following technical solutions:

An eccentric mechanism, the eccentric mechanism comprising:

An eccentric block component;

A counterweight structure for balancing the eccentric block component on the same axis as the shaft when rotating;

A heat dissipating component is coupled to the eccentric block component and is provided with a plurality of fan blade structures and is driven to rotate synchronously with the working component under the driving of the driving mechanism to dissipate heat for the structural unit.

Preferably, the heat dissipation component comprises:

A mounting structure for mounting the eccentric block component and the counterweight structure, comprising a mounting base, a first placement area and a second placement area provided on the mounting base, wherein the first placement area is for the placement of the counterweight structure and the second placement area is for the placement of the eccentric block component;

A fan structure, provided on the mounting structure, comprising a plurality of blade structures.

Preferably, the counterweight structure comprises:

A first counterweight section;

A second counterweight section, wherein the upper end surface of the second counterweight section is lower than the upper end surface of the first counterweight section and wherein the upper end surface of the second counterweight section is used to support and/or mount the eccentric block component, and/or;

A third counterweight section, provided on the eccentric block component.

Preferably, the counterweight structure comprises:

A first counterweight section;

A second counterweight section, wherein the first counterweight section is formed from a radial extension of the second counterweight section and wherein the upper end surface of the second counterweight section is used to support and/or mount the eccentric block component, and/or;

A third counterweight section, provided on the eccentric block component.

Preferably, the mounting base comprises:

A first base, provided for a first positioning mechanism for positioning the counterweight structure;

A second base, provided for a second positioning mechanism for positioning the eccentric block component;

The joint section formed by the connection between the first base and the second base;

Preferably, the first positioning mechanism comprises:

A first support component provided at a lower section of the first base for supporting the counterweight structure;

A first clamping component provided on an upper section of the first base for clamping the counterweight structure.

Preferably, the first support component comprises at least one first supporting section, wherein the first supporting section is a projection extending from an inner wall of the first base in the radial direction and wherein the first supporting sections are connected and/or disconnected from each other.

Preferably, the first supporting section comprises at least one first support piece, and the first support piece of the supporting section is detachably coupled to the counterweight structure and/or the lower section of the first base for supporting the counterweight structure.

Preferably, the first support component comprises at least one first support piece, wherein the first support pieces are connected and/or disconnected from each other. The first support piece comprises:

A first connecting section, a projection formed by extending from a lower end surface of the first base in the axial direction;

A first supporting section, a protrusion structure extending from the first connecting section in a radial direction for supporting the counterweight structure.

Preferably, the first clamping component comprises at least one first clamping piece, wherein the first clamping pieces are connected and/or disconnected from each other.

The first clamping piece comprises:

A first connecting section, a projection formed by extending from a lower end surface of the first base in the axial direction;

A first clamping section, a protrusion structure extending from the first connecting section in a radial direction for blocking the axial movement of the counterweight structure.

Preferably, the area enclosed by the joint section, the first clamping section, the first base, and the first supporting section constitutes the first placement area.

Preferably, the second positioning mechanism comprises:

A second support component provided at a lower section of the second base for supporting the eccentric block component;

A second clamping component provided on an upper section of the second base for clamping the eccentric block component.

Preferably, the second support component comprises at least one second supporting section, wherein the second supporting section is a projection extending from an inner wall of the second base in the radial direction and wherein the section supporting sections are connected and/or disconnected from each other.

Preferably, the second supporting section comprises at least one second support piece, and the second support piece is detachably connected to the eccentric block component and/or the lower section of the second base for supporting the eccentric block component.

Preferably, the second support component comprises at least one second support piece, wherein the second support pieces are connected and/or disconnected from each other. The second support piece comprises:

A second connecting section, a projection formed by extending from a lower end surface of the second base in the axial direction;

A second supporting section, a protrusion structure extending from the second connecting section in a radial direction for supporting the eccentric block component.

Preferably, the second clamping component comprises at least one second clamping piece, wherein the second clamping pieces are connected and/or disconnected from each other. The second clamping piece comprises:

A second connecting section, a projection formed by extending from an upper end surface of the second base in the axial direction;

A second clamping section, a protrusion structure extending from the second connecting section in a radial direction for blocking the axial movement of the eccentric block component.

Preferably, the area enclosed by the joint section, the second clamping section, the second base, and the supporting end surface of the second supporting section constitutes the second placement area.

Preferably, the supporting end surface corresponding to the first supporting section provided on the counterweight structure is located at the same horizontal plane as the supporting end surface of the second supporting section, and the space enclosed by a clamping surface of the second clamping section, an inner wall of the second base, and a supporting end surface of the first supporting section constitutes the second placement area.

Preferably, the first supporting section is provided with a first connecting passageway, and a lower section of the eccentric block component is provided with a second connecting passageway, and when the eccentric block component is placed in the second placement area, the eccentric block component is integrated with the structure by the fastener penetrating into first connection passageway and second connection passageway.

Preferably, the fan blade structure is provided on an outer end surface of the mounting structure, comprising:

A fan blade structure, distributed along the circumferential direction of the mounting base, and a protrusion structure extending from an outer end surface of the mounting base in the radial direction;

A second flow guiding passage, a space enclosed by adjacent fan blade structures, wherein the airflow generated by the rotation of the fan blade structure as the drive mechanism and/or the working component and/or the fan blade structure rotate is output to the working component through the second flow guiding passage to dissipate heat generated by the power tool.

Preferably, the fan blade structure is provided on an outer end surface of the mounting structure, comprising:

A fan blade structure, distributed along the circumferential direction of the mounting base, and a protrusion structure extending from an outer end surface of the mounting base in the radial direction;

An outer ring structure, an annular structure provided around an outer end of the fan blade structure;

A second flow guiding passage, a space enclosed by the adjacent fan blade structure and outer ring structure, wherein the airflow generated by the rotation of the fan blade structure as the drive mechanism and/or the working component and/or the fan blade structure rotate is output to the working component through the second flow guiding passage to dissipate heat generated by the power tool.

Preferably, the direction in which the fan blade structure is provided is not parallel to the axial direction of the mounting base, thereby forming an A-angle. Preferably, the fan blade structure comprises:

A first blade, longitudinally provided along an outer end surface of the first base;

A second blade, longitudinally provided along an outer end surface of the second base.

Preferably, the end faces of first blade and/or second blade are arranged in a horizontal structure.

Preferably, the end faces of first blade and/or second blade are arranged in a curved structure.

Preferably, the end faces of first blade and/or second blade are arranged in an irregular horizontal structure.

Preferably, the first blade and/or second blade are equidistantly distributed.

Preferably, the first blade and/or second blade are and are not equidistantly distributed.

A power tool that comprises:

A housing mechanism;

A driving mechanism provided in the housing structure;

An output mechanism connected to the driving mechanism and provided in the housing structure;

A working component for the operation of the product;

The output mechanism comprises:

An output shaft having one end connected to the drive mechanism;

The above eccentric mechanism, wherein the eccentric mechanism is connected to the working component through a rotating shaft.

Preferably, the housing mechanism comprises:

A first housing component provided in a lateral direction for wrapping the internal member;

A second housing component provided longitudinally relative to the first housing component;

The first housing assembly is provided with a first gripping device for the operator to grip, and/or the second housing component is provided with a second gripping device for the operator to grip, wherein the first gripping device and/or the second gripping device is arranged in an uneven structure.

Preferably, the first housing component comprises:

A first housing, provided with a control structure for controlling the opening and/or closing of the tool;

A second housing, connected to first housing;

A third housing, connected to second housing;

The first gripping device is provided on first housing and/or second housing and/or third housing.

Preferably, the second housing component and third housing are coupled, wherein the first gripping device is provided on first housing and/or second housing and/or third housing between the control structure and the second housing component.

Preferably, the first gripping device comprises:

At least a first gripping section for the operator to adjust fingers for the handheld tool;

A first connection section, wherein the adjacent first gripping section is coupled by first connecting section and is provided as a smooth transition connection.

Preferably, the first gripping sections are provided to the curvature of an operator's fingers, and the respective first gripping sections may be arranged in different concave curved surfaces.

Preferably, the first gripping device is provided with a first anti-slip structure for preventing the sliding of fingers when the operator operates; the first anti-slip structure is provided on first housing and/or second housing and/or third housing and covers the first gripping device; the first anti-slip structure is provided as a bump and/or provided in a striped structure and/or provided as a bonded structure;

Preferably, the second gripping device is provided on a side of the second housing component away from the control structure.

Preferably, the second gripping device is laterally provided.

Preferably, the second gripping device comprises:

At least a second gripping section for the operator to adjust fingers for the handheld tool;

A second connecting section, wherein the adjacent second gripping section is coupled by the second connecting section and is provided as a smooth transition connection;

Preferably, the second gripping sections are provided to the curvature of an operator's fingers, and the respective second gripping sections may be provided in different concave curved surfaces.

Preferably, the second gripping device is provided with a second anti-slip structure for preventing the sliding of fingers when the operator operates; the second anti-slip structure is provided on the second housing component and covers the second gripping device; the second anti-slip structure is provided as a bump and/or provided in a striped structure and/or provided as a bonded structure.

Preferably, it further comprises a flow guiding device provided on the second housing component for guiding the heat dissipation of the power tool, comprising:

A flow guide;

At least one first flow guiding passage, wherein the first flow guiding passage is

provided on the flow guide and wherein the guiding path of the first flow guiding passage is

provided at an angle with the flow guide.

Preferably, the flow guide comprises:

The body of the flow guide;

A baffle, wherein the baffle is provided on the body of the flow guide;

The passage formed between the baffle and the flow guide body, and/or the passage formed between adjacent flow guides, constitutes the first flow guiding passage. Preferably, the end of the baffle is provided with a first joint section and/or a second joint section and is connected to the flow guide body through the first joint section and/or the second joint section, wherein the first joint section and/or second joint section and the joint surface of the flow guide body are provided at an angle.

Preferably, the baffle body is provided with a first end surface and a second end surface, wherein the first end surface and second end surface are oppositely provided and wherein the first end surface is composed of a space enclosed by the first joint section and the second surface is composed of a space enclosed by the second joint section;

Preferably, the first flow guiding passage comprises:

A first passage, wherein the first passage is an opening provided on the body of the flow guide;

A second passage, wherein the second passage is formed by a joint surface, a first end surface, and a second end surface,

The flow path formed by the first passage and/or second passage is gradually increased.

The present invention achieves the following beneficial effects:

(1) The eccentric mechanism of the present invention is provided with a heat-dissipating component, and the fan blade structure on the heat-dissipating component is synchronously rotated with the working component under the driving of the driving mechanism, and it may serve as a structural unit for mounting the eccentric mechanism, such as for heat dissipation for a power tool, to greatly increase the service life of the equipment or tools that involve the structural unit. For instance, when used in a power tool, the service life of the power tool can be greatly improved.

(2) The electric power tool of the present invention comprises an eccentric mechanism provided with a heat-dissipating component, wherein the fan blade structure is driven by a rotating medium generated by the driving mechanism, that is, a wind power, and outputs the heat generated by the power tool housing through the first flow guiding passage to the external space through the second flow guiding passage and the first flow guiding passage. The direction of the airflow generated by the rotation of the fan blade structure can also be transported in the direction of the working component, that is, from the direction in which the protective cover is provided toward the direction of the working component, so as to achieve the heat dissipation of the power tool and thus achieve heat dissipation. In particular, the heat dissipation of the working components not only improves the service life of the power tool, but it also protects the medium that is worked on, such as the surface of a car, so that the power tool can achieve good results when used for grinding.

The additional aspects and advantages of the present invention will be set forth in part in the description which follows.

### DRAWINGS DESCRIPTION

The drawings described herein are intended to provide a further understanding of the invention and are intended to be a part of the invention. In the drawings:

FIG. 1 is a cross-sectional view of a prior art device;

FIG. 2 is a schematic structural view of a prior art device;

FIG. 3 is a schematic structural view of a first embodiment of an eccentric mechanism according to the present invention;

FIG. 4 is a cross-sectional view of a first embodiment of an eccentric mechanism according to the present invention;

FIG. 5 is a front elevational view of a first embodiment of an eccentric mechanism according to the present invention;

FIG. 6 is a schematic structural view of a second embodiment of an eccentric mechanism according to the present invention;

FIG. 7 is a front elevational view of a second embodiment of an eccentric mechanism according to the present invention;

FIG. 8 is a front elevational view of a third embodiment of an eccentric mechanism according to the present invention;

FIG. 9 is a schematic structural view of a first embodiment of a fan structure according to the present invention;

FIG. 10 is a schematic structural view of a second embodiment of a fan structure according to the present invention;

FIG. 11 is a cross-sectional view of a second embodiment of a fan structure according to the present invention;

FIG. 12 is a first schematic structural view of a first embodiment of a mounting structure according to the present invention;

FIG. 13 is a second schematic structural view of a first embodiment of a mounting structure according to the present invention;

FIG. 14 is a first schematic structural view of a second embodiment of a mounting structure according to the present invention;

FIG. 15 is a second schematic structural view of a second embodiment of a mounting structure according to the present invention;

FIG. 16 is a schematic structural view of a third embodiment of a mounting structure according to the present invention;

FIG. 17 is a schematic structural view of an embodiment of a counterweight structure according to the present invention;

FIG. 18 is a front elevational view of a first embodiment of a counterweight structure according to the present invention;

FIG. 19 is a front elevational view of a second embodiment of a counterweight structure according to the present invention;

FIG. 20 is a schematic structural view of an embodiment of an eccentric block component according to the present invention;

FIG. 21 is a cross-sectional view of an embodiment of an eccentric block component according to the present invention;

FIG. 22 is a schematic structural view of an embodiment of a power tool according to the present invention;

FIG. 23 is a cross-sectional view of an embodiment of a power tool according to the present invention;

FIG. 24 is a schematic structural view of an embodiment of a first gripping device according to the present invention;

FIG. 25 is a schematic structural view of an embodiment of a second gripping device according to the present invention;

FIG. 26 is a schematic structural view of an embodiment of a second housing component according to the present invention;

FIG. 27 is a first schematic structural view of an embodiment of a guiding device according to the present invention;

FIG. 28 is a second schematic structural view of an embodiment of a guiding device according to the present invention;

FIG. 29 is a third schematic structural view of an embodiment of a guiding device according to the present invention;

FIG. 30 is a fourth schematic structural view of an embodiment of a guiding device according to the present invention;

FIG. 31 is a fifth schematic structural view of an embodiment of a guiding device according to the present invention;

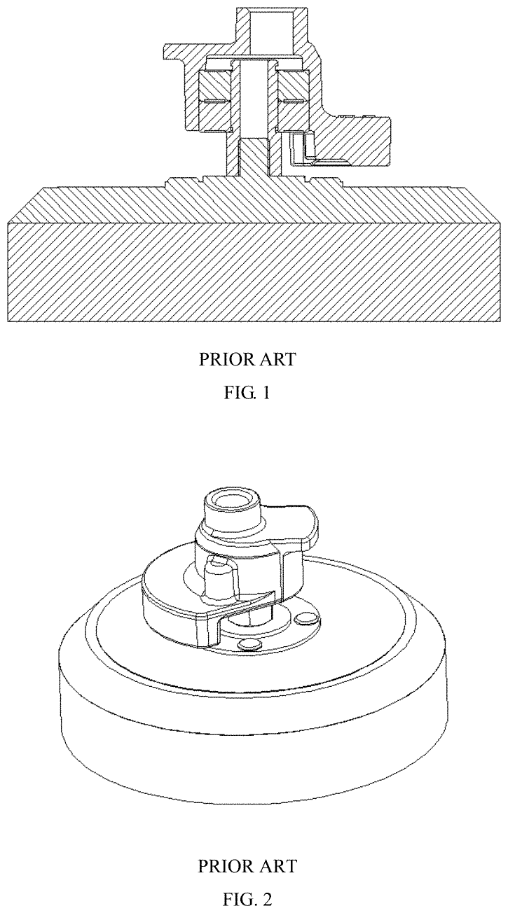

### DETAILED DESCRIPTION

The technical solutions of the embodiments of the present invention will be clearly and completely described in below with reference to the accompanying drawings. It is to be apparent that the described embodiments are only part of the embodiments of the invention and not all of the embodiments. All other embodiments obtained by a person of ordinary skill in the art based on the described embodiments of the invention, without departing from the scope of the invention, are within the scope of the invention. In the description of the present invention, it is to be understood that terms such as “center,” “longitudinal,” “lateral,” “length,” “width,” “thickness,” “upper,” “lower,” “front,” “rear,” “left,” “right,” “perpendicular,” “parallel,” “top,” “bottom,” “inner,” “outer,” “clockwise,” “counterclockwise” or the like that indicate orientation or positional relationships based on orientation or positional relationships shown in the drawings, are merely for the convenience of describing the present invention and simplifying the description rather than indicating or implying that the device or component referred to must have a particular orientation or must be constructed and operated in a particular orientation. Therefore, such terms should not be construed as limiting the present invention.

Moreover, the terms “first” and “second” are used for descriptive purposes only and are not to be construed as indicating or implying a relative importance or implicitly indicating the number of technical features indicated. Thus, features defining “first” and “second” may include one or more features, either explicitly or implicitly. In the description of the present invention, the meaning of “a plurality” is two or more, unless clearly and specifically defined otherwise.

In the present invention, unless explicitly stated and defined otherwise, the terms “mount,” “couple,” “connect,” “affix,” and the like shall be understood broadly. For instance: it may be a fixed connection, a detachable connection, or an integral connection; it may be a mechanical connection or an electrical connection; or it may be a direct connection or it may be an indirect connection through an intermediate medium, which may be an internal connection between two components. For those skilled in the art, the specific meanings of the above terms in the present invention can be understood on a case-by-case basis.

In the present invention, unless expressly stated and defined otherwise, where the first feature is “on” or “under” the second feature, it may include direct contact between the first feature and the second feature and may include that the first and second features are not in direct contact but are in contact through additional features between them. Moreover, where the first feature is “above,” “over,” or “on top of” the second feature, it shall include that the first feature is directly above and obliquely above the second feature or merely indicate that the first feature is at a level higher than the second feature. Where the first feature is “below,” “beneath,” or “under” the second feature, it shall include the first feature is directly below and obliquely below the second feature or merely indicate that the first feature is at a level lower than the second feature.

Unless otherwise defined, technical terms or scientific terms used herein shall be taken to mean the ordinary meaning of the person of ordinary skill in the art to which the invention pertains. The words “first”, “second” and similar terms used in the description and claims of the present invention do not denote any order, quantity, or importance, but are merely used to distinguish different components. Similarly, the words “a” or “an” and the like do not denote a quantity limitation but mean that there is at least one.

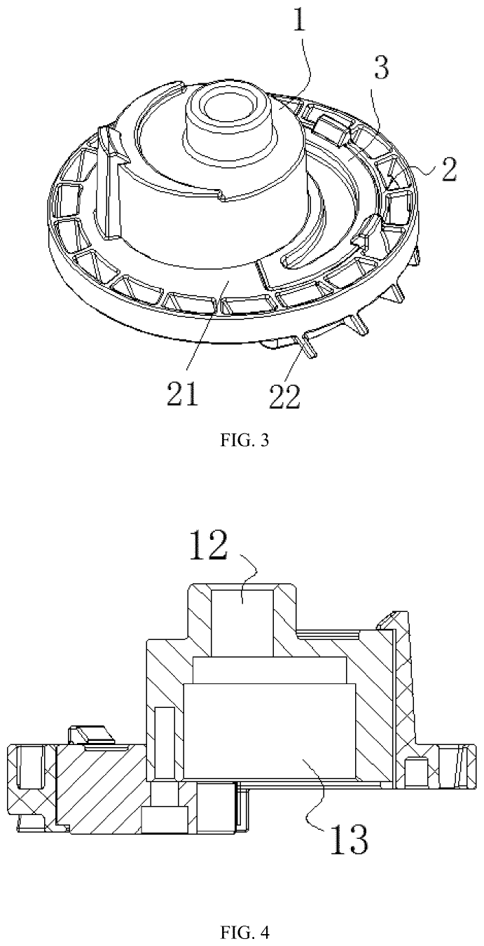

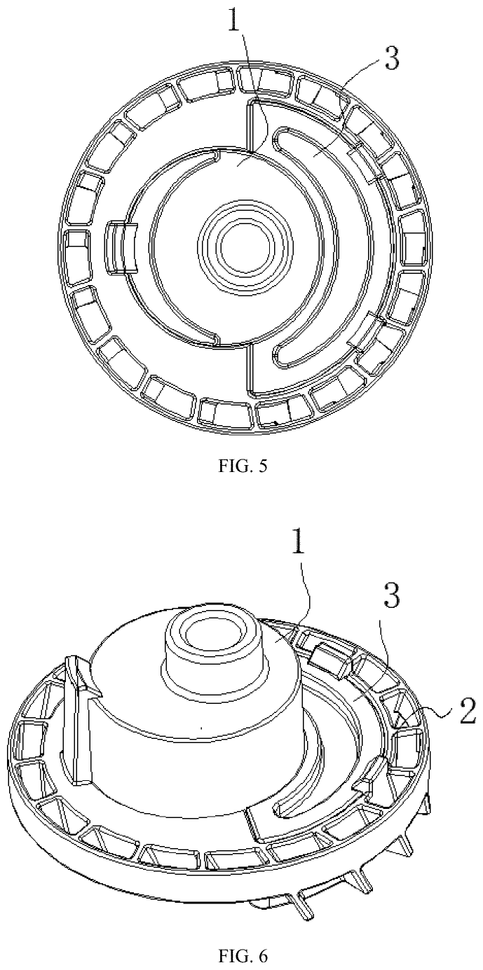

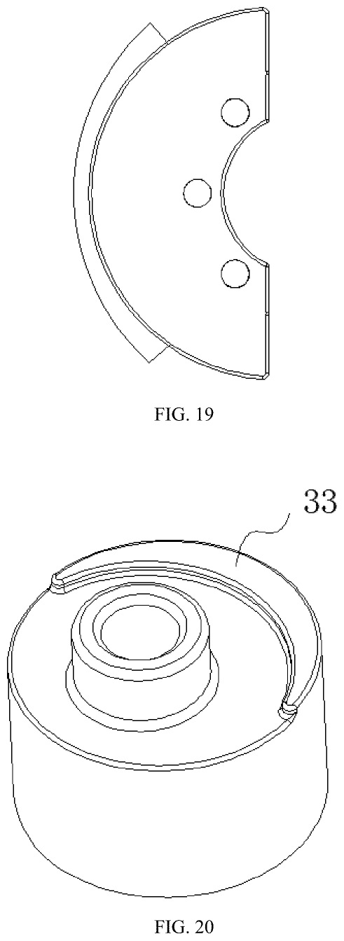

As shown in FIGS. 3-21, as an embodiment of the present invention, eccentric mechanism 500 of the present invention may be used for the connecting portion of various output mechanisms 300 and mainly function as an axial connection. In this embodiment, the eccentric mechanism 500 is used as an example to illustrate a power tool. On the one hand, it is used to drive the working component 400 to rotate to operate the power tool; on the other hand, it is provided with a heat-dissipating component 2 (see FIG. 3), and it is used in the embodiment of the present invention for heat dissipation for the power tool. Specifically, it is used to illustrate a grinder as a type of power tool. In this embodiment, the heat-dissipating component 2 is provided on the eccentric mechanism 500, that is, the working component 400, such as a grinding component, and is mainly used for dissipating the heat of the grinding component. Because the grinding component is extremely prone to heat generation when it is used continuously or for long periods of time, especially during continuous grinding because of the faster rotation speed, on the one hand, heating of the grinding component greatly reduces its life, and, on the other hand, the heat of the grinding component will be transmitted to the workpiece, such that the workpiece will also generate heat, thereby affecting the quality of the grinding and even damaging the workpiece due to the increase in temperature. Therefore, the heat-dissipating component 2 of the present invention is provided on the eccentric mechanism 500, and in particular, can dissipate heat generated by the grinding component, thereby improving the service life of the power tool.

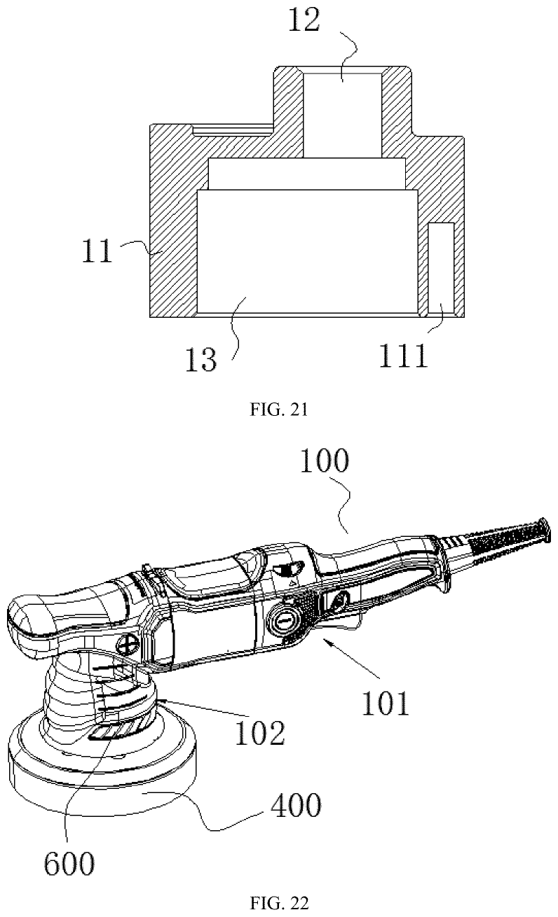

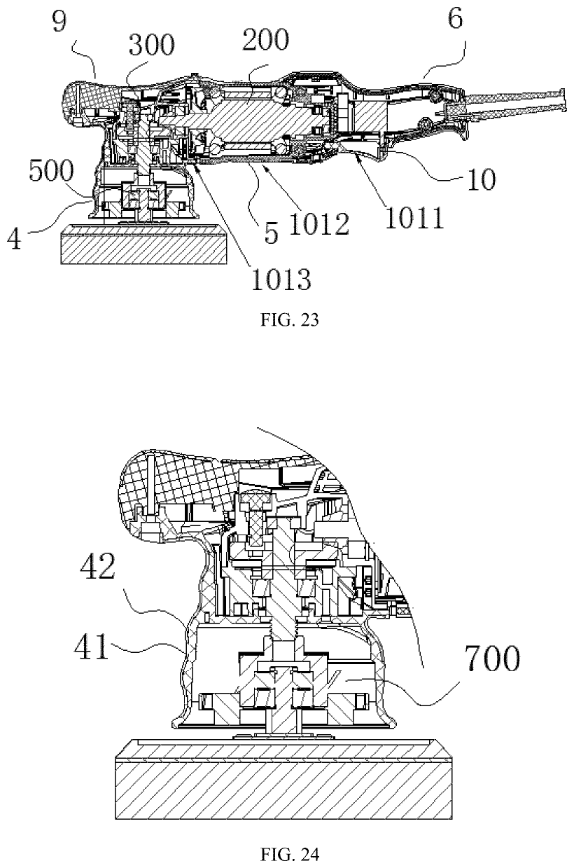

In the present embodiment, as shown in FIG. 3, the eccentric mechanism 500 comprises an eccentric block component 1, the heat-dissipating component 2, and a counterweight structure 3, wherein the heat-dissipating component 2 is connected to the eccentric block component 1 and may be provided as an integral structure and may also be provided as a separate structure. From the viewpoint of the positional structure, if the working component 400 is positioned at the lower end, the heat-dissipating component 2 may be provided above the eccentric block component 1, that is, the heat-dissipating component 2, the eccentric block component 1, and the working component 400 are sequentially arranged from top to bottom, or may be provided below the eccentric block component 1, that is, the eccentric block component 1, the heat-dissipating component 2, and the working component 400 may be sequentially arranged from top to bottom. Moreover, the heat-dissipating component 2 of the present invention is provided with a plurality of blade structures 221, which are driven to rotate synchronously with the working component 400 under the drive of a driving mechanism 200 (see FIG. 23) to achieve heat dissipation of the power tool, especially for the working component 400, such as the heat dissipation of a grinding component. In the present embodiment, as shown in FIGS. 4 and 21, eccentric block component 1 comprises eccentric block body 11, wherein one end of eccentric block body 11 is provided with axis channel 12 for mounting to an output shaft and the other end is provided with axis channel 13. The axes for axis channel 12 and axis channel 13 are not on the same line. By adapting through a mounting structure 21 and counterweight structure 3 included in the heat-dissipating component 2 of the present embodiment, the axis channel 12 is on the same line as the axis of axis channel 13 when the eccentric block component 1 drives the working component 400 during the rotation operation.

According to an embodiment of the present invention, heat-dissipating component 2 comprises the mounting structure 21 and a fan structure 22, wherein mounting structure 21 is mainly used for mounting counterweight structure 3 and eccentric block component 1 and for mounting and connecting counterweight structure 3 and eccentric block component 1. Fan structure 22 may be provided as an integrated structure with mounting structure 21 and may also be provided as a separate structure. When provided as a separate structure, fan structure 22 is preferably provided on the outside of mounting structure 21 to not block mounting structure 21. This ensures that the fan blade structure 221 circulates air during rotation, thereby circulating air from the inside of the power tool housing to the outside, preferably in the direction in which the working component 400 is mounted, to achieve heat dissipation of the power tool. When provided as an integrated structure, the fan structure 22 is preferably provided at the outer end of mounting structure 21 to ensure that the fan blade structure 221 circulates air during rotation, thereby circulating air from the inside of the power tool housing to the outside, preferably in the direction in which the working component 400 is mounted, to dissipate heat from the power tool.

In the present embodiment, the counterweight structure 3 is used to balance the eccentric mechanism 500, so that the two axes of the eccentric block component 1 are on the same line when rotating. The counterweight structure 3 of the present embodiment may be provided as an integrated structure with mounting structure 21 and may also be a separate structure. However, when it is provided as a separate structure, the counterweight structure 3 is located on mounting structure 21 within a first placement area 212 (see FIGS. 12 and 14), and the axis of counterweight structure 3 is not on the same line as the axis of the transmission shaft. Counterweight structure 3 is used to balance the axis of eccentric block component 1. The counterweight structure 3 of the present embodiment may also be configured as an integrated structure with the eccentric block component 1 and may also be a separate structure. However, when it is provided as a separate structure, counterweight structure 3 is located on mounting structure 21 within the first placement area 212, and the axis of counterweight structure 3 is not on the same line as the axis of the transmission shaft. Counterweight structure 3 may be a standalone structure, may be a separate structure, and may also be provided on eccentric block component 1; all are within the scope of the present invention.

According to an embodiment of the present invention, as shown in FIGS. 3-5, as a first embodiment, counterweight structure 3 comprises a first counterweight section 31 and a second counterweight section 32 (see FIG. 17), wherein the first counterweight section 31 and the second counterweight section 32 may be provided as an integrated structure and may be provided as a separate structure. When provided as a separate structure, when they are joined together, the first counterweight section 31 and the second counterweight section 32 are basically connected through abutment. In the present embodiment, the upper end surface of the second counterweight section 32 is slightly lower than the upper end surface of the first counterweight section 31, wherein the upper end surface of the second counterweight section 32 is used to support eccentric block component 1 or is used to mount eccentric block component 1. When the eccentric block component 1 abuts against the upper end surface of the second counterweight section 32 in a contactable or gap fit manner, the eccentric block component 1 is supported by the second counterweight section 32. In the present embodiment, a third counterweight structure may also include a third counterweight section 33, wherein the third counterweight section 33 is provided on the eccentric block component 1. From the provided position, the third counterweight section 33 is provided to a side of eccentric block component 1, that is, above the eccentric block body 11, that is, on a side of eccentric block body 11 away from the first counterweight section 31 and the second counterweight section 32, the purpose of which is to achieve a balance between the rotation of the eccentric mechanism 500 and the working component 400. In the present embodiment, the provision of the third counterweight section 33 is defined according to the overall layout of eccentric block component 1. When the provision of the first counterweight section 31 and the second counterweight section 32 are sufficient to balance the rotation of eccentric block component 1, the third counterweight section 33 may be unused or, according to the provision of the first counterweight section 31 and the second counterweight section 32, the model and location required for the third counterweight section 33 may be provided correspondingly. In terms of implementation and structural provision, structures are not limited to the present embodiment and the drawings. For example, in the present embodiment, the third counterweight section 33 is provided as a crescent-shaped structure and may also be provided in various other shapes, such as an ellipse, a circle, a square, a polygon, or a star.

According to an embodiment of the present invention, as shown in FIGS. 6 as 7, as a second embodiment, counterweight structure 3 comprises the first counterweight section 31 and the second counterweight section 32, wherein the first counterweight section 31 and the second counterweight section 32 may be provided as an integrated structure and may also be provided as a separate structure. When provided as a separate structure, when combined together, the first counterweight section 31 and the second counterweight section 32 are substantially connected through abutment. In the present embodiment, the first counterweight section 31 is a protrusion formed from a radial extension of the second counterweight section 32. The shape is not limited, as long as the rotating of eccentric block component 1 and the operation of working component 400 of the present embodiment may be balanced. The upper end surface of the second counterweight section 32 is used to support eccentric block component 1 or is used to mount eccentric block component 1. When the eccentric block component 1 abuts against the upper end surface of the second counterweight section 32 in a contactable or gap fit manner, the eccentric block component 1 is supported by the second counterweight section 32. In the present embodiment, the provision of the third counterweight section 33 is defined according to the overall layout of eccentric block component 1. When the provision of the first counterweight section 31 and the second counterweight section 32 are sufficient to balance the rotation of eccentric block component 1, the third counterweight section 33 may be unused or, according to the provision of the first counterweight section 31 and the second counterweight section 32, the model and location required for the third counterweight section 33 may be provided correspondingly. In terms of implementation and structural provision, structures are not limited to the present embodiment and the drawings. For example, in the present embodiment, the third counterweight section 33 is provided as a crescent-shaped structure and may also be provided in various other shapes, such as an ellipse, a circle, a square, a polygon, or a star.

According to an embodiment of the present invention, as shown in FIGS. 12-16, mounting structure 21 is mainly used for mounting and placement of counterweight structure 3 and eccentric block component 1, comprising a mounting base 211, a first placement area 212, and a second placement area 213. The first placement area 212 and second placement area 213 are both provided on the mounting base 211, and may be fully or partially provided on mounting base 211. Moreover, first placement area 212 and second placement area 213 have a spatial concept and are provided with an area for the placement of an item and may provide an independent space and may also provide an intersecting space, that is, there is a section of the intersection area where the item may be placed. In the present embodiment, counterweight structure 3 is mounted and placed within the first placement area 212, and eccentric block component 1 is mounted and placed within the second placement area 213 to respectively position counterweight structure 3 and eccentric block component 1 and to effectively prevent the axial and radial movement of counterweight structure 3 and eccentric block component 1, ensuring that the counterweight structure 3 and eccentric block component 1 are mounted and placed stably so that working component 400, such as a grinding component, rotates smoothly when the power tool is operated, thus achieving better grinding results. Mounting base 211 of the present embodiment comprises a first base 214 and a second base 215, as well as a joint section 216, wherein the joint section 216 is formed at the connection of the first base 214 and the second base 215. In the present embodiment, the first placement area 212 is provided on a first base 214, and a first positioning mechanism 7 is correspondingly provided on the first base 214 for the positioning of counterweight structure 3. When counterweight structure 3 is placed and mounted within the first placement area 212, the location of counterweight structure 3 is positioned by the first positioning mechanism 7, effectively preventing the axial and radial movement of counterweight structure 3, ensuring the counterweight structure 3 is stable during the grinding process, and that the working component 400 does not slip or move when rotating. The second placement area 213 is provided on the second base 215, and a second positioning mechanism 8 is correspondingly provided on the second base 215 for the positioning of the eccentric block component 1. When eccentric block component 1 is placed and mounted within second placement area 213, the location of eccentric block component 1 is positioned by the second positioning mechanism 8 to effectively prevent the axial and radial movement of eccentric block component 1, ensuring the stable placement of eccentric block component 1 and, in the grinding process, that working component 400 does not slip or move when rotating.

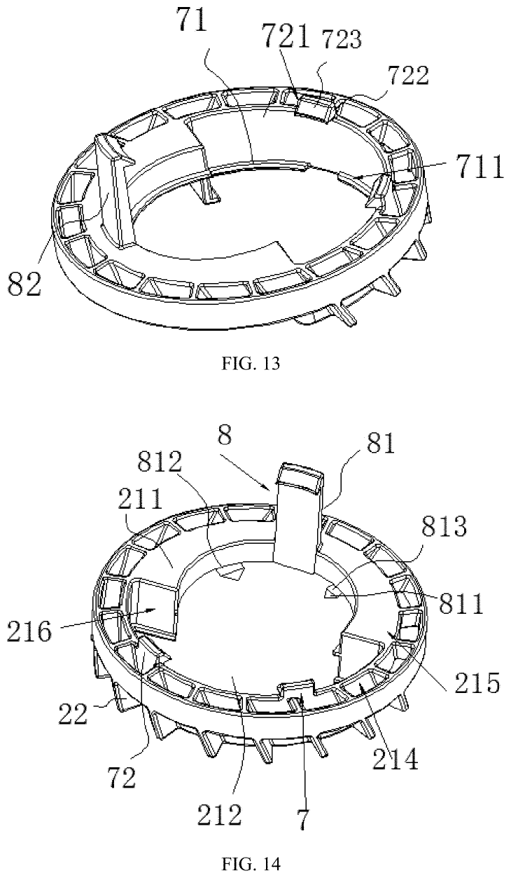

According to an embodiment of the present invention, as shown in FIGS. 13 and 15, the first positioning mechanism 7 comprises a first supporting component 71 and a first clamping component 72, wherein the first supporting component 71 is provided on the lower part of the first base 214, and the first clamping component 72 is provided on the upper part of the first base 214 to jointly achieve the positioning of counterweight structure 3, which is mainly used in the present invention to limit the axial movement of counterweight structure 3, wherein the first supporting component 71 is used to support counterweight structure 3, that is, the lower end of counterweight structure 3 is placed on first supporting component 71 to achieve support through the first supporting component 71, effectively preventing the movement of counterweight structure 3 in the direction of gravity. The first clamping component 72 is used for clamping onto the upper part of counterweight structure 3 to effectively prevent the counterweight structure 3 from moving with the rotation, and negatively affecting the working component, such as a grinding component.

According to an embodiment of the present invention, as shown in FIG. 13, the first supporting component 71, as one embodiment of the present invention, comprises at least one supporting section 711. The supporting section 711 is a projection extending from an inner wall of the first base 214 in the radial direction, wherein the space provided by the projection is sufficient for the placement of a partial structure on the lower end of counterweight structure 3 to sufficiently ensure that counterweight structure 3 does not slip. In the present embodiment, supporting section 711 may be a ring formed continuously and forming an inner circumference around the lower inner wall of the first base 214 or may be a partial structure forming an inner circumference around the lower inner wall of the first base 214. Moreover, the support section 711 may be a disconnected structure, having adjacent support structures with a part or all of the adjacent support sections being disconnected, and supporting counterweight structure 3. When provided as disconnected support sections, that is, an opening is formed at the break between supporting sections 711, corresponding precisely to the location of the upper first clamping component 72, the opening is provided mainly for when the mounting structure 21 is an integrated structure to facilitate the integral molding of mounting structure 21 so that the first supporting component 71 and the first clamping component 72 are the integrated structure of mounting structure 21 with the mounting base 211 to facilitate the overall mounting of the power tool, greatly providing production efficiency.

According to an embodiment of the present invention, as shown in FIG. 15, the first supporting component 71, as a second embodiment of the present invention, comprises at least one support piece 712, wherein the support piece 712, as an independent structure, is mainly detachably coupled to the lower section of the counterweight structure 3 and/or the first base 214 to support counterweight structure 3. In the present embodiment, the support piece 712 may be provided to completely wrap the bottom section of mounting base 211 or be a structure of the bottom section of counterweight structure 3, wherein a connecting hole or the like is provided on the upper surface of the support piece 712 to facilitate coupling with counterweight structure 3, or to connect to counterweight structure 3 and mounting base 211 to form a whole, all of which can support counterweight structure 3, which are all within the scope of the present embodiment.

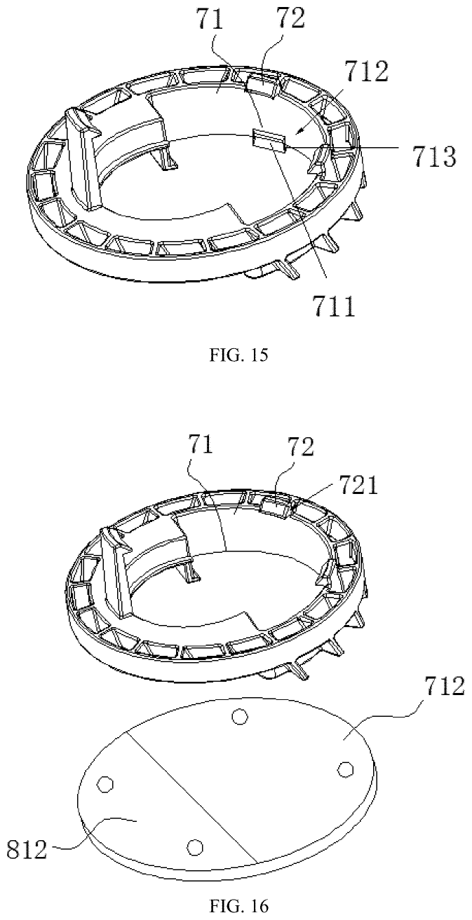

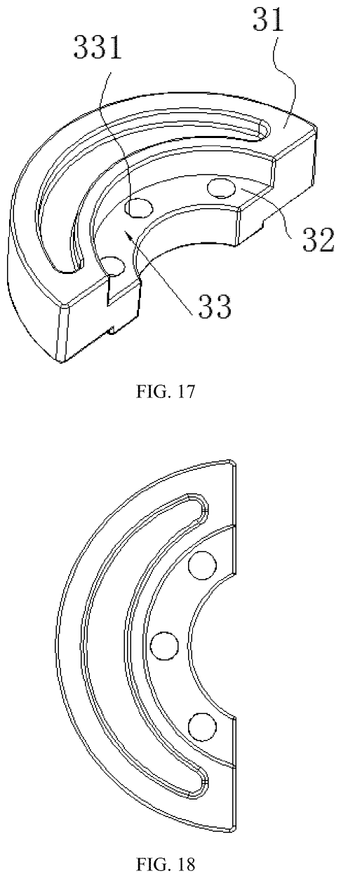

According to an embodiment of the present invention, as shown in FIG. 16, the first supporting component 71, as a third embodiment of the present invention, comprises at least one support piece 712, wherein support pieces 712 may be connected and/or disconnected. The support piece 712 comprises a connecting section 713 and the supporting section 711, wherein the connecting section 713 is a protrusion extending from the lower end surface of the first base 214 in the axial direction and wherein the supporting section 711 is a protrusion extending from connecting section 713 in the radial direction to jointly form the support piece 712 of the present embodiment to support the counterweight structure 3. The placement space enclosed by the supporting section 711 is sufficient for the placement of a partial structure on the lower end of the counterweight structure 3 to sufficiently ensure that the counterweight structure 3 does not slip. In the present embodiment, the supporting sections 711 may be a continuous ring formed around the lower section of the first base 214 or may be a partial structure formed around the lower section of the first base 214. A disconnected structure has supporting sections that are disconnected and can support the counterweight section 3. Additionally, support pieces 712 may also be independent components, that is, the support pieces provided on the lower section of the first base 214 in intervals, which may be at equal intervals or may also be provided at unequal intervals, all are within the scope of the present embodiment.

According to an embodiment of the present invention, as shown in FIG. 13, the first clamping component 72 is used to cooperate with the first supporting component 71, and under the support of the first support component 71 on the lower section of counterweight structure 3, it is also used to clamp the counterweight structure 3 through the first clamping component 72 in order to limit the axial direction of counterweight structure 3 to ensure the stability of the mounting of counterweight structure 3. The first clamping component 72 of the present embodiment comprises at least one clamping piece 721, wherein the clamping piece 721 may be connected and/or disconnected, the clamping piece 721 comprising a first connecting section 722 and a first clamping section 723, wherein the first connecting section 722 is a protrusion extending from the upper end surface of the first base 214 in the axial direction and the first clamping section 723 is a protrusion extending from the first connecting section 722 in the radial direction to jointly form the clamping piece 721 of the present embodiment to clamp counterweight structure 3 and thus position counterweight structure 3. The clamping surface of the first clamping section 723 abuts the upper end surface of the counterweight structure 3 upper end surface, effectively preventing the loosening and movement of the upper end of the counterweight structure 3 in the axial direction. In the present embodiment, the first clamping section 723 may be a continuous ring formed around the upper section of the first base 214 and may also be a partial structure formed around the upper section of the first base 214. Moreover, the first clamping section 723 may have a disconnected structure. If the first clamping sections 723 are disconnected, they can together clamp and position counterweight structure 3. In addition, clamping piece 721 may also be independent components, that is, can be clamping pieces provided on the upper section of first base 214 in intervals, and may be provided at equal intervals or at unequal intervals, and may be provided singly and may also be provided as a plurality. All are within the scope of the present embodiment.

According to the embodiment of the present invention, as shown in FIGS. 13 and 14, counterweight structure 3 is placed on the first placement area 212 within the mounting base 211 which is composed of a plurality of positioning surfaces and the like. In the present embodiment, the first placement area 212 of counterweight structure 3 is composed of a region enclosed by the joint section 216, the first clamping section 723, the first base 214, and the supporting sections 711. The bottom section of the counterweight structure 3 abuts the supporting surface formed by the supporting sections 711, one side surface of the side section abuts the joint surface formed by the joint section 216, and the other side surfaces are limited by the end surface formed by the inner wall of the first base 214. The end surface of the upper section is clamped by the first clamping section 723 and abuts the clamping surface formed by the first clamping section 723. The majority of the structures of counterweight structure 3 are located within the space formed in the first base 214 for the mounting and placement of counterweight structure 3 of the present embodiment, ensuring the stability of the mounting of counterweight structure 3. In the present embodiment, the radial direction of the counterweight structure 3 is limited by the inner wall of the first base 214 and the joint surface of the joint section 216, and the axial direction thereof is limited by the supporting sections 711 and the first clamping section 723 for the mounting and positioning of the counterweight structure 3.

According to the embodiment of the present invention, as shown in FIGS. 12 and 14, the second positioning mechanism 8 comprises a second supporting component 81 and a second clamping component 82, wherein the second supporting component 81 is provided on the lower section of the second base 215 and the second clamping component 82 is provided on the upper section of the second base 215 to jointly achieve the positioning of eccentric block component 1, which is mainly used in the present invention to limit the axial movement of eccentric block component 1, wherein the second supporting component 81 is used to support eccentric block component 1, that is, the lower end of eccentric block component 1 is placed on the second supporting component 81 to achieve support through the second supporting component 81, effectively preventing the movement of eccentric block component 1 in the direction of gravity. The second clamping component 82 is used for clamping onto the upper section of eccentric block component 1 to effectively prevent eccentric block component 1 from moving with the rotation, negatively effecting the working component, such as a grinding component.

According to an embodiment of the present invention, as shown in FIG. 12, the second supporting component 81, as one embodiment of the present invention, comprises at least one supporting section 811, wherein the supporting section 811 is a projection extending from an inner wall of the second base 215 in the radial direction. The placement space enclosed by the projection is sufficient for the placement of a partial structure on the lower end of the eccentric block component 1 to sufficiently ensure that eccentric block component 1 does not slip. In the present embodiment, supporting section 811 may be a continuous ring formed around the lower section of the second base 215 or may be a partial structure forming an inner circumference around the lower inner wall of the second base 215. The supporting section 811 may be a disconnected structure with disconnected supporting sections partially or fully adjacent each other with all supporting eccentric block component 1. When provided as a disconnection, that is, an opening is formed at the break between supporting sections, corresponding precisely to the location of the upper second clamping component 82, the opening is provided mainly for when the mounting structure 21 is an integrated structure to facilitate the integral molding of mounting structure 21 so that second supporting component 81 and second clamping component 82 are the integrated structure of mounting structure 21 with mounting base 211 to facilitate the overall mounting of the power tool, greatly providing production efficiency.

According to an embodiment of the present invention, as shown in FIG. 14, the second supporting component 81, in the second embodiment of the present invention, comprises at least one support piece 812, wherein a support piece 812, as an integrated structure, is mainly detachably coupled to the eccentric block component 1 and/or the lower section of the second base 215 to support the eccentric block component 1. In the present embodiment, the support piece 812 may be provided to completely encapsulate the bottom section of the mounting base 211 or be a structure of the bottom section of the eccentric block component 1, wherein a connecting hole or the like is provided on the upper surface of the support piece 812 to facilitate coupling with eccentric block component 1, or to connect to the eccentric block component 1 and mounting base 211 to form a whole, all of which can support eccentric block component 1, all of which are within the scope of the present embodiment.

According to an embodiment of the present invention, as shown in FIG. 14, the second supporting component 81 comprises at least one support piece 812, wherein support pieces 812 may be connected and/or disconnected and wherein support piece 812 comprises connecting a section 813 and the supporting section 811, wherein the connecting section 813 is a protrusion extending from the lower end surface of the second base 215 in the axial direction and the supporting section 811 is a protrusion extending from the connecting section 813 in the radial direction to jointly form the support piece 812 of the present embodiment to support the eccentric block component 1. The placement space enclosed by the supporting section 811 is sufficient for the placement of a partial structure on the lower end of the eccentric block component 1 to sufficiently ensure that the eccentric block component 1 does not slip. In the present embodiment, the supporting section 811 may be a continuous ring formed around the lower section of the second base 215 or may be a partial structure formed around the lower section of the second base 215. Moreover, the supporting section 811 may be a disconnected structure with disconnected supporting sections partially or fully adjacent each other with all supporting the eccentric block component 1. In addition, support piece 812 may also be independent components, that is, the support pieces provided on the upper section of the second base 215, that are provided on the upper section of the second base 215 in intervals, may be provided at equal intervals and may also be provided at unequal intervals, may be provided singly and may also be provided as a plurality. All are within the scope of the present embodiment.

According to an embodiment of the present invention, as shown in FIG. 12, the second clamping component 82 is used to cooperate with the second supporting component 81, and under the support of the second supporting component 81 on the lower section of the eccentric block component 1, it is also used to support the upper section of the eccentric block component 1 through the second clamping component 82 in order to limit the axial direction of eccentric block component 1 to ensure the stability of the mounting of eccentric block component 1. The second clamping component 82 of the present embodiment comprises at least one clamping piece, wherein the clamping pieces may be connected and/or disconnected, with the clamping piece comprising a second connecting section 821 and a second clamping section 822. The second connecting section 821 is a protrusion extending from the upper end surface of the second base 215 in the axial direction and the second clamping section 822 is a protrusion extending from the second connecting section 821 in the radial direction to jointly form the clamping piece of the present embodiment to clamp the eccentric block component 1 and thus position the eccentric block component 1. The clamping surface of the second clamping section 822 abuts the upper end surface of the eccentric block component 1 to effectively prevent the loosening and axial movement of the upper end of the eccentric block component 1. In the present embodiment, the second clamping section 822 may be a continuous ring formed around the upper section of the second base 215 and may also be a partial structure formed around the upper section of the second base 215. Moreover, a disconnected structure is provided between clamping sections 822, that is, partially or fully adjacent clamping sections 822 are disconnected and can all clamp and position the eccentric block component 1. In addition, clamping pieces may also be independent components, that is, the clamping pieces provided on the upper section of the second base 215, that are provided on the upper section of the second base 215 in intervals, may be provided at equal intervals or may be provided at unequal intervals, may be provided singly and may also be provided as a plurality. All are within the scope of the present embodiment.

According to an embodiment of the present invention, as shown in FIGS. 3, 5, 20, and 21, as a first embodiment of the eccentric block component 1, eccentric block component 1 is placed on the second placement area 213 within the mounting base 211 (see FIG. 12) and is composed of a plurality of positioning surfaces and the like. In the present embodiment, the second placement area 213 of eccentric block component 1 is composed of an area enclosed by the second clamping section 822, the second base 215, and the supporting section 811. The bottom section of eccentric block component 1 abuts the supporting surface formed by the supporting sections 811, and the side surface of a side section is limited by the end surface formed by an inner wall of the second base 215. The end surface of the upper section is clamped by the second clamping section 822 and abuts the clamping surface formed by the second clamping section 822. The majority of the structures of the eccentric block component 1 are located in the space formed within the second base 215 for the mounting and placement of the eccentric block component 1, ensuring the mounting stability of the eccentric block component 1. In the present embodiment, the radial direction of eccentric block component 1 is limited by the inner wall of the second base 215, and the axial direction thereof is limited by supporting section 811 and the second clamping section 822 for mounting and positioning of eccentric block component 1.

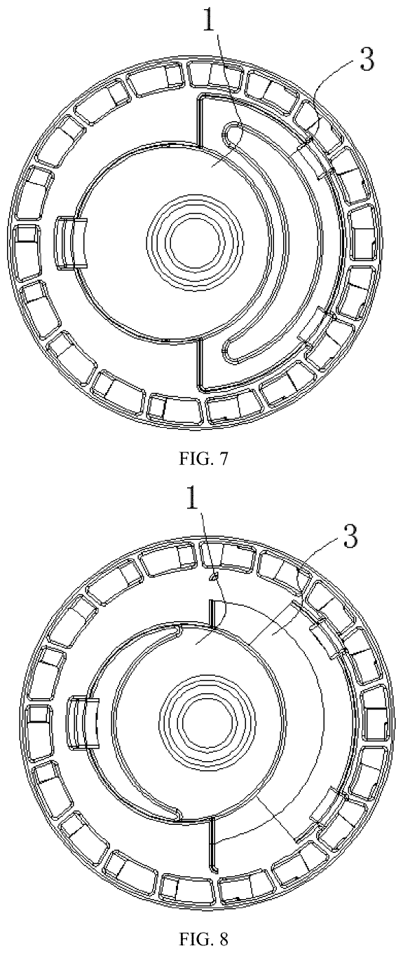

According to an embodiment of the present invention, as shown in FIGS. 6 and 7, as a second embodiment of the eccentric block component 1, eccentric block component 1 is placed on the second placement area 213 within the mounting base 211 (see FIG. 12) and is composed of a plurality of positioning surfaces and the like. In the present embodiment, the second placement area 213 of the eccentric block component 1 is composed of a space enclosed by the second clamping section 822, the second base 215, and the supporting sections 811, as well as the a supporting. The bottom section of eccentric block component 1 abuts the supporting end surface formed by supporting sections 811 and the first supporting section. The supporting end surface corresponding to the first supporting section provided on the counterweight structure 3 is at the same level as the supporting end surface of the supporting section 811 to facilitate the stable placement of eccentric block component 1. The side surface or the outer circumference of a side section of eccentric block component 1 is limited by the end surface formed by an inner wall of the second base 215. The end surface of the upper section is clamped by the second clamping section 822 and abuts the clamping surface formed by the second clamping section 822. The majority of the structures of eccentric block component 1 are located in the space formed within the second base 215 for the mounting and placement of the eccentric block component 1 of the present embodiment, ensuring the mounting stability of the eccentric block component 1. In the present embodiment, the radial direction of eccentric block component 1 is limited by the inner wall of the second base 215, and the axial direction thereof is limited by supporting section 811 and the second clamping section 822 for mounting and positioning of eccentric block component 1. When eccentric block component 1 is located on the second base 215 and counterweight structure 3, the bearing structure provided inside eccentric block component 1 also abuts the supporting end surface formed by the first supporting section of counterweight structure 3 and is limited by the supporting end surface formed by the first supporting section, mainly in the axial direction, preventing the bearing structure from slipping out of the axis channel 13 of the lower end of eccentric block component 1. In the present embodiment, when the lower end surface of eccentric block body 11 and the bottom section component of the bearing structure are located on the second base 215 and counterweight structure 3, the stability of the eccentric block component 1 and the bearing structure, as well as working component 400, the mounting base 211, and other connections are further determined. Furthermore, a connecting passageway 331 (see FIG. 17) is also provided on the first supporting section, and a connecting passageway 111 (see FIG. 21) is provided on the lower section of eccentric block component 1. When eccentric block component 1 is located within the second placement area 213, the eccentric block component 1 and the counterweight structure 3 are integrated by a fastener penetrating through the connecting passageway 331 and the connecting passageway 111, such that the counterweight structure 3 and the eccentric block component 1, as a whole, are rotated with better stability at high speeds.

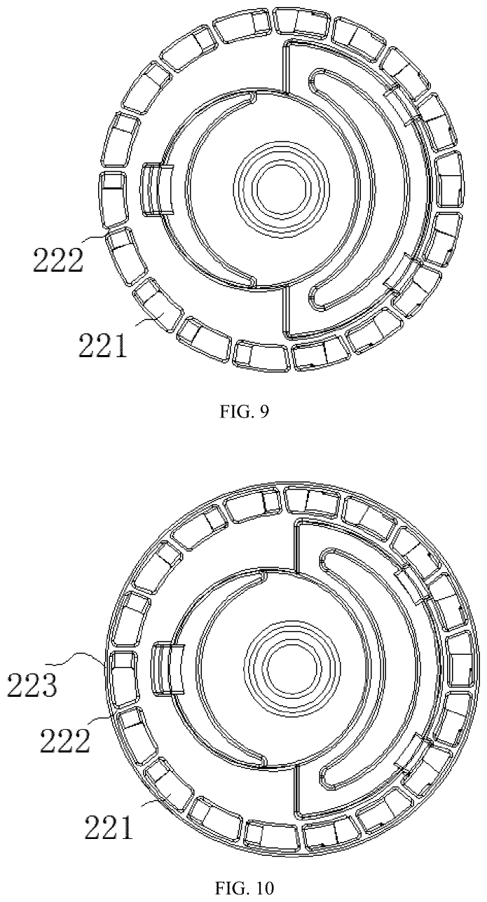

According to an embodiment of the present invention, as shown in FIG. 9, as a first embodiment of the fan structure 22, the fan structure 22 is provided on the outer end surface of the mounting structure 21 and may be provided as an integrated structured with the mounting structure 21 or may be a separate structure. However, when provided as a separate structure, fan structure 22 is detachably connected to mounting structure 21 by a connecting piece. The present embodiment is illustrated as an integrated structure, and when provided as an integrated structure, it facilitates the mounting of the overall structure. In the present embodiment, fan structure 22 comprises a fan blade structure 221 and a second flow guiding channel or passageway 222, wherein the fan blade structure 221 is distributed along the circumferential direction of the mounting base 211 and is mainly distributed along the outer circumferential direction of mounting base 211. Moreover, it is a protrusion extending from the outer end surface of mounting base 211 in the radial direction, formed under the rotation of the rotating axis. The fan blade structure 221 formed by these protrusions rotates to form a heat dissipation medium, that is, wind, to dissipate the heat of the power tool, especially to dissipate the heat of the working component 400. Moreover, the heat-dissipating medium generated under the rotation of the fan blade structure 221, that is, the wind power, is further transported into the power tool housing through the second flow guiding passageway 222 and is sent to the working component 400. The present embodiment preferably sends the wind flow generated by the rotation of flan blade structure 221 in the direction of working component 400, that is, from the direction of the protective cover to the direction of the working component 400. The second flow guiding passageway 222 of the present embodiment may be composed of a space formed between adjacent fan blade structures 221, and with the rotation of the driving mechanism 200 and/or working component 400 and/or fan blade structure 221, the airflow or wind power generated by the rotation of fan blade structure 221 is output in the direction of the working component 400 by the second flow guiding passageway 222 to dissipate the heat generated by the power tool for heat dissipation, especially for dissipating the heat of the working component 400. This not only improves the service life of the power tool, but it can also better protect the medium that the working component 400 operates on, such as the surface of a car, for better grinding/polishing results when the power tool, as a grinder or polisher, is operated.

According to an embodiment of the present invention, as shown in FIG. 10, as the second embodiment of the fan structure 22, the fan structure 22 is provided on the outer end surface of the mounting structure 21 and may be provided as an integrated structured with the mounting structure 21 and may also be a separate structure. However, when provided as a separate structure, the fan structure 22 is detachably connected to the mounting structure 21 by a connecting piece. The present embodiment is illustrated as an integrated structure, and when provided as an integrated structure, it facilitates the mounting of the overall structure. In the present embodiment, fan structure 22 comprises the fan blade structure 221 and the second flow guiding passageway 222, as well as an outer ring structure 223, wherein the outer ring structure 223 is a ring structure provided around the outer end section of the fan blade structure 221 and may be used to strengthen the mounting base 211 and further concentrate and divert the airflow generated by the fan blade structure 221 for a better guiding effect. The fan blade structure 221 of the present embodiment is distributed along the mounting base 211 in the circumferential direction and mainly distributed along the mounting base 211 in the outer circumferential direction. Moreover, it is a protrusion extending from the outer end surface of mounting base 211 in the radial direction, formed under the rotation of the rotating axis. The fan blade structure 221 formed by these protrusions rotates to form a heat dissipation medium, that is, wind, to dissipate the heat of the power tool, especially to dissipate the heat of the working component 400. Moreover, the heat-dissipating medium generated by the rotation of the fan blade structure 221, that is, the wind power, is further transported into the power tool housing through the second flow guiding passageway 222 and is sent to the working component 400. The present embodiment preferably sends the wind flow generated by the rotation of flan blade structure 221 in the direction of working component 400, that is, from the direction of the protective cover toward the working component 400. The second flow guiding passageway 222 of the present embodiment may be composed of a space formed between adjacent fan blade structures 221 and outer ring structure 223, and with the rotation of the driving mechanism 200 and/or working component 400 and/or fan blade structure 221, the airflow or wind power generated by the rotation of fan blade structure 221 is output in the direction of the working component 400 by the second flow guiding passageway 222 to dissipate the heat generated by the power tool, especially for dissipating the heat of the working component 400. This not only improves the service life of the power tool, but it can also better protect the medium that the working component 400 operates on, such as the surface of a car, for better grinding/polishing results when the power tool, as a grinder, is operated.

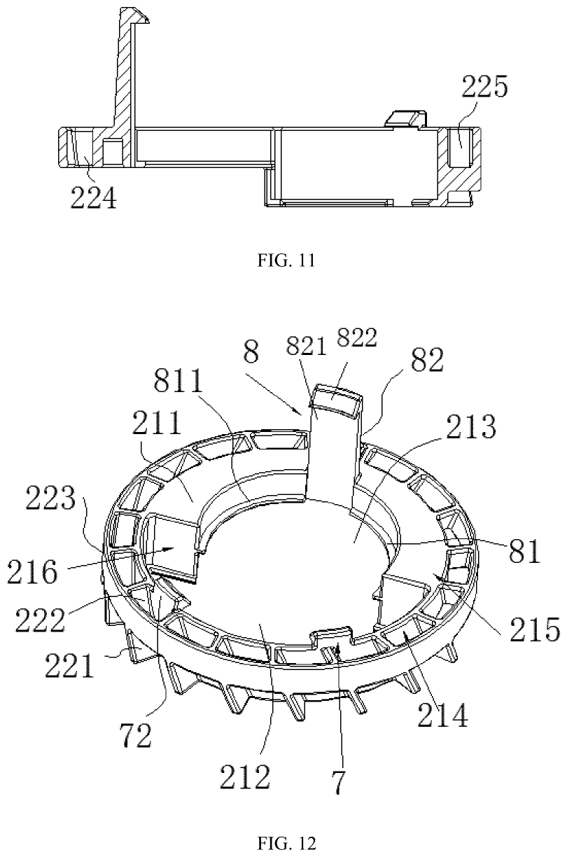

According to an embodiment of the present invention, as shown in FIG. 11, the fan blade structure 221 includes a plurality of blades, including a blade 224 and a blade 225. The length of the blade 224 is provided along the outer end surface of the first base 214, that is, on the outer end surface of the first base 214, wherein the blade 224 substantially fills the outer end surface of the first base 214. The length of the blade 225 is provided along the outer end surface of the second base 215, that is, on the outer end surface of the second base 215, wherein the blade 225 substantially fills the outer end surface of the second base 215. Thus, as shown in the figure, the length of the blade 224 is slightly less than the length of the blade 225. The length of the blade 224 and the blade 225 of the present embodiment is not limited to the description of the embodiments of the present invention, and other structures thereof are within the scope of the present invention. To further improve heat dissipation, the blade 224 and the blade 225 of the present embodiment are protrusions extending from the end surface of the mounting base 211 that are not parallel with the axial direction of the mounting base 211. From a positional perspective, the blade 224 forms an angle with the first base 214, and the blade 225 forms an angle with the second base 215. In the present embodiment, the end surface of the blade 224 may be provided as a horizontal structure. To further improve heat dissipation, wherein its end surface, that is, the outer surface, may also be provided as a curved structure, that is, another structure that can improve wind power or airflow may be provided on its end surface. Of course, it can also be provided as another irregular horizontal structure, all of which are within the scope of the present embodiment. Similarly, the end surface of the blade 225 may be disposed as a horizontal structure. To further improve heat dissipation, its end surface, that is, the outer surface, may also be provided as a curved structure, that is, another structure that can improve wind power or airflow may be provided on its end surface. Of course, it can also be provided as another irregular horizontal structure, all of which are within the scope of the present embodiment. In the present embodiment, when the blade 224 is disposed on the outer circumference or end surface of the first base 214 and adjacent blades are distributed equidistantly, they may also not be distributed equidistantly. The preferred scheme is an equidistant structure, the purpose of which is to provide more uniformly guide flow or airflow. When the structure is not equidistant, another auxiliary airflow circulation structure may be provided on the blade 224 or on the first base 214 to improve the guiding force of the fan blade structure 221, which in turn improves or enhances or better enables better heat dissipation and provides better conditions for heat dissipation of the working component 400.

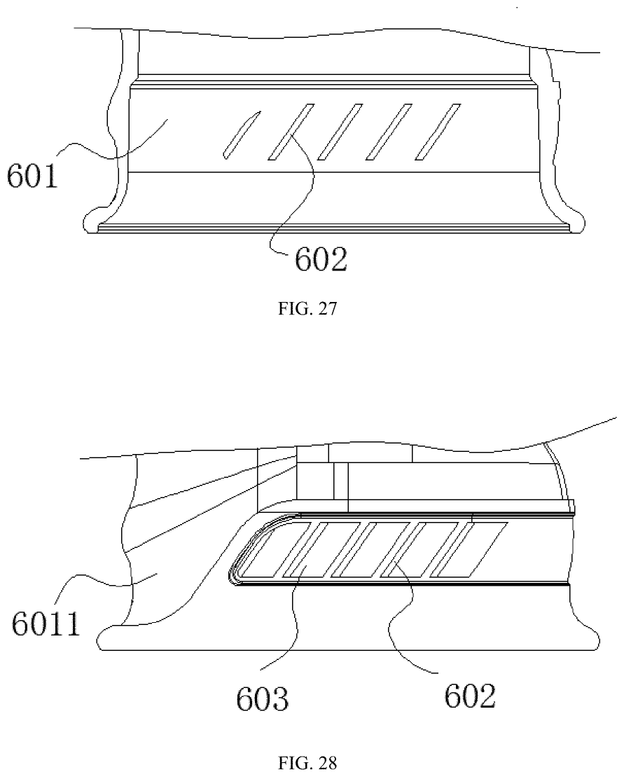

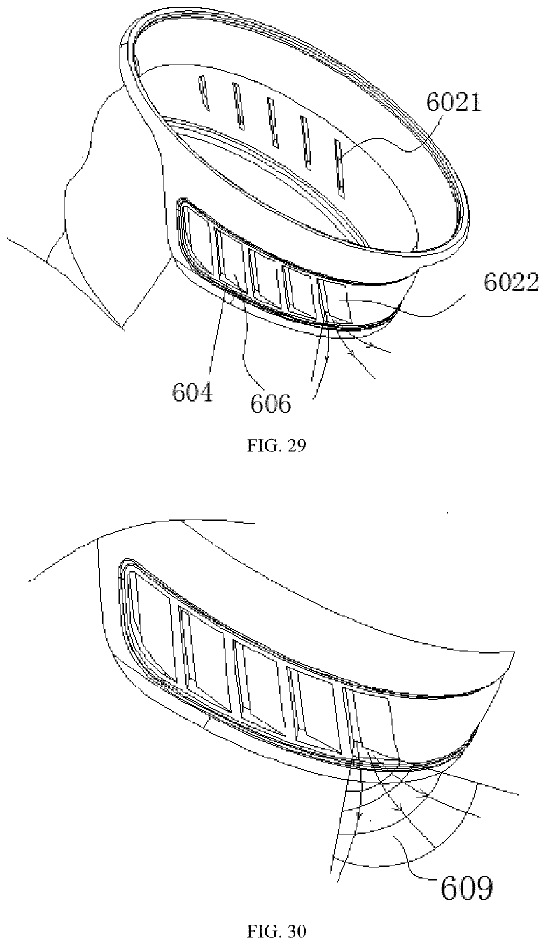

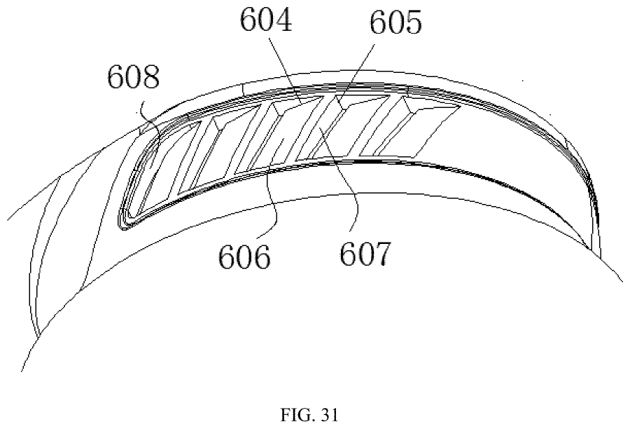

According to an embodiment of the present invention, as shown in FIGS. 26-31, a type of flow guiding device 600 is used to guide heat dissipation of the mounting structure, and heat generated by the working component 400 or the power tool of the present embodiment during work is mainly dissipated through the heat-dissipating mechanism. Corresponding to the conducting of heat from the working component or housing or equipment or the interior of any structure by the flow guiding device 600 of the present embodiment, the flow guiding device 600 of the present embodiment mainly serves to divert the flow, which is equivalent to a passageway for circulation when heat is dissipated. The flow guiding baffles or device 600 of the present embodiment comprises a flow guide 601 and first flow guiding passageway 602 provided on flow guide 601, wherein a plurality of first flow guiding passageways 602 may be provided in the circumferential direction on the flow guide 601 or be provided as a plurality in the heat dissipation area or be provided in intervals in a plurality of heat dissipation areas. Moreover, the first flow guiding passageways 602 are provided in the heat dissipation areas in the radial direction or the first flow guiding passageways 602 are provided symmetrically on the flow guides 601, all of which are within the scope of the present invention. In the present embodiment, the guiding path 609 (see FIG. 30) of the first flow guiding passageway 602 is provided at an angle with the flow guide 601, that is, the direction of the heat guided by the first flow guiding passageway 602 forms a certain angle with the flow guide 601 and is at least not perpendicular to the surface or end surface of the flow guide 601. The flow path 609 formed by the direction of circulation and the surface or end surface of the flow guide 601 is provided at an angle such that the flow of heat or the flow path 609 emanating from the inside of the working component or equipment flows away from the operator, that is, the heat will not be directed towards the operator's body or at least will not dissipate heat towards the operator, thereby injuring the operator. By providing the first flow guiding passageway 602 of the present embodiment, when dissipating heat from items or the working component or the tool, the operator can grip the tool or equipment or other items to properly prevent hot air from blowing on the operator.

According to an embodiment of the present invention, the flow guide 601 comprises a flow guide body 6011 and baffles 603 (see FIG. 28), wherein the baffles 603 are provided in intervals on the flow guide body 6011. Flow guide 601 may be used as a standalone unit or may be provided on a certain structure, that is, become a partial or local structure of that structure, all of which is within the scope of the present embodiment. As shown in the figure, flow guide 601 is illustrated as a single structure with the second housing component 102 or as a local structure on the second housing component 102. When the flow guiding device 600 of the present embodiment is provided on a power tool, as shown in the figure, when provided on the second housing component 102, the flow guiding device 600 is mainly used to achieve heat dissipation of heat generated by the power tool during rotation or heat generated by the working component 400 during operation, dissipating the heat in a first housing component 101 and a second housing component 102 of the power tool to the external space. Heat can be dissipated more quickly with the flow guiding device 600 of the present embodiment, lowering the temperature of the tool and greatly providing the tool's service life. In the present embodiment, a plurality of baffles 603 are provided, wherein baffles 603 are provided on flow guide body 6011 at intervals, and a passageway is formed between adjacent baffles 603, that is, the first flow guiding passageway 602 is formed, wherein a passageway is formed between two outer baffles 603 and the flow guide body 6011, which also constitutes the first flow guiding passageway 602 of the present invention. Therefore, the first flow guiding passageway 602 of the present embodiment is provided by the positional relationship of the baffles 603 and the flow guide body 6011. The baffles 603 of the present embodiment may be provided equidistantly or may not be provided equidistantly, all of which is within the scope of the present embodiment.

According to an embodiment of the present invention, a first joint section 604 and/or a second joint section 605 is provided on the end of the baffle 603 and coupled to the flow guide body 6011 through the first joint section 604 and/or the second joint section 605. A first end surface 606 and a second end surface 607 are provided on the body of the baffle 603, and the first end surface 606 is provided on an end surface of the upper section of the body of the baffle 603, wherein the first end surface 606 of the present embodiment is formed by the space between the first joint sections 604. The second end surface 607 is provided on another end surface of the upper section of the body of the baffle 603, wherein the second end surface 607 is formed by the space between the second joint sections 605. Moreover, the first end surface 606 and the second end surface 607 are oppositely provided. Because the first joint section 604 and the second joint section 605 of the present embodiment are provided at an angle to the flow guide body 6011, that is, they are provided at a certain angle, there is also an angle formed by the first end surface 606 and second end surface 607 and the flow guide body 6011 that is at least non-parallel or perpendicular to the end surface of the flow guide body 6011 or a joint surface 608. In the present embodiment, the first flow guiding passageway 602 comprises a first passageway 6021 and a second passageway 6022, wherein the first passageway 6021 is provided at an opening on the flow guide body 6011, wherein the opening may be provided as a structure with a certain depth to concentrate heat to be conducted out of the opening; the second passageway 6022 is a space formed between the joint surface 608 of the flow guide body 6011 and the first end surface 606 and second end surface 607 of the baffle 603. Moreover, to quickly conduct the heat from within the chamber or housing or tool, the guiding path 609 formed by the first passageway 6021 and the second passageway 6022 of the present embodiment is gradually enlarged, that is, for the guiding path 609 formed by the first passageway 6021 and second passageway 6022, the starting end is gradually increased from the beginning of the first passageway 6021 to the terminal of the second passageway 6022 so that the conducted heat passes through the guiding path 609 formed by the first passageway 6021 and second passageway 6022. The enlargement of the dimension of the guiding path 609, or the enlargement of the area of the guiding path 609 or the enlargement of the volume of the guiding path 609, that is, in short, the enlargement of the size of the guiding path 609 can quickly conduct heat to the external environment. In the present embodiment, the guiding path 609 formed by the first passageway 6021 may be provided equidistantly, wherein, once heat enters the second passageway 6022, the guiding path 609 formed by the second passageway 6022 is gradually enlarged to facilitate rapid heat dissipation.

According to an embodiment of the present invention, a type of heat-dissipating mechanism 700 is also disclosed for dissipating workpiece heat. For example, when used for a power tool, it is used to dissipate heat generated when internal structures of the power tool and workpiece components are working. For example, when the present embodiment is illustrated as a power tool, the heat-dissipating mechanism 700 of the present embodiment is mainly used to dissipate heat generated by the operation of the power tool. In the present embodiment, the heat-dissipating mechanism 700 comprises the second housing component 102, the heat-dissipating component 2 (provided on the eccentric block component 1 as shown in the figure), and the flow guiding device 600, wherein the heat-dissipating component is provided within the second housing component 102, and the flow guiding device 600 is provided on the second housing component 102 and may cover the second housing component 102 or may be provided as a partial or local structure on the second housing component 102. When the power tool is operating, heat generated by internal components during rotation, as well as heat generated by the working component 400 at high speeds is dissipated by the heat-dissipating component of the present embodiment and conducted to the external space by the flow guiding device 600 of the present embodiment, wherein the heat-dissipating component 2 of the present embodiment is provided as in the above embodiment.

As shown in FIGS. 22-25, as an embodiment of the present invention, a type of power tool can be applied to grinding or polishing and can be configured based on the nature of a product. Corresponding to the above structure, the eccentric mechanism 500, in particular, it may be used as a grinder or polisher or even other tools that are driven to rotate by the driving mechanism 200, for all of which, the eccentric mechanism 500 of the present invention is applicable. The power tool of the present invention comprises a housing mechanism 100, the driving mechanism 200 located within the housing mechanism 100, the output mechanism 300 coupled with the driving mechanism 200, and the working component 400. When the power tool of the present invention is a polisher, the working component 400 may be referred to as a polishing component for the polishing of a workpiece such as the surface of a car. When the power tool of the present invention is a grinder, the working component 400 may be referred to as a grinding component, for example, for grinding the surface of a car, with the working component. In the description of the embodiments of the present invention, it is illustrated as a grinder. For other tools, such as a polisher, the technical configuration of the embodiments of the present invention may be referenced, and the eccentric mechanism 500 and other specific structures may be adjusted based on the application of the power tool, all of which are within the scope of the present invention. The driving mechanism 200 in the embodiment of the present invention may be referred to as a motor or other component as long as they can provide power, the power source of which is not limited to motors. The present invention is illustrated as a grinder, and the corresponding working component 400 is provided as a grinding component to grind the surface of the workpiece, such as a car. The output mechanism 300 of the present invention is coupled to the driving mechanism 200, mainly to guide the power source of the driving mechanism 200 to provide a driving force for the working component 400. To achieve the work of the working component 400, the output mechanism 300 of the present invention may comprise a transmission mechanism such as a gear to guide power to a transmission shaft of the working component 400 and an eccentric mechanism 500, wherein an end of the transmission shaft is coupled to a transmission mechanism, such as a gear and the other end is coupled to the eccentric mechanism 500. The power is output to drive the rotation of the eccentric mechanism 500. Thus, the working component 400 is rotated by the eccentric mechanism 500 to grind a medium, such as the workpiece.

According to an embodiment of the present invention, the housing mechanism 100 may be used on most products to enclose internal structures, on the one hand, protecting internal structures from damage and, on the other hand, protecting against dust and rain, thereby improving the service life of the product. In the present embodiment, preferably, the housing mechanism 100 is used within a power tool for enclosing and protecting the structures included in the power tool, such as the drive mechanism 200, the output mechanism 300, the transmission mechanism, and various connection mechanisms. In the present embodiment, housing mechanism 100 comprises the first outer housing component 101 and second outer housing component 102, both of which encapsulate internal structures. As shown in the figure, the first outer housing component 101 is provided laterally with respect to the direction of placement, and the corresponding second outer housing component 102 is provided longitudinally. The housing mechanism 100 of the various power tools is formed together with the first outer housing component 101. The angle formed between the first housing component 101 and the second housing component 102 is not limited to being completely perpendicular, that is, 90 degrees, and another corresponding angle may be formed. The angle may be provided based on the positional relationship after the connection between the specific mountings, and the first outer housing component 101 encapsulates internal structures and the like. In the present embodiment, when the housing mechanism 100 is used on a power tool, the internal components encapsulated by the first outer housing component 101 are preferably a driving mechanism 200, output mechanism 300, and transmission mechanism and the internal components encapsulated by the second outer housing component 102 are preferably an output mechanism 300 or transmission mechanism. When the power tool of the present embodiment is, for example, a grinder, the internal components encapsulated by the corresponding first outer housing component 101 are the driving mechanism 200, such as a motor or the like, and the output mechanism 300 is a gear transmission structure or the like, and the internal components encapsulated by the second outer housing component 102 are the eccentric mechanism or the like, the free end of the second outer housing component 102 connects to a grinding component for grinding of a medium, such as the surface of a car.

A first gripping device 4 is provided on the first outer housing component 101 of the present embodiment. When operating the power tool, the operator may perform operations by conveniently gripping the tool by holding the first gripping device 4. To further ensure that the gripping of the tool is convenient for the operator and that it does not slip when in use, an uneven structure is provided on the first gripping device 4 for the operator to conveniently grip. Similarly, a second gripping device 5 is provided on the second outer housing component 102. When operating the power tool, the operator may perform operations by conveniently gripping the tool by holding the second gripping device 5. To further ensure that the gripping of the tool is convenient for the operator and that it does not slip when in use, an uneven structure is provided on the second gripping device 5 for the operator to conveniently grip. When a third gripping device 6 is used together with the second gripping device 5, one hand grips the power tool of the present embodiment from an upper section of a housing 1011 by gripping the third gripping device 6, and the biasing direction is to hold the third gripping device 6 from top to bottom with respect to the first housing component, that is, the biasing direction is from top to bottom, correspondingly, and is used on the housing 1011 of the power tool. The other hand grips the second housing component 102 from the left side of the second housing component 102 by gripping the second gripping device 5, and the biasing direction is to grip the second gripping device 5 from left to right with respect to the first housing component, that is, the direction of the force is relatively from left to right, and acts on the second housing component 102 of the power tool. By gripping the second gripping device 5 and third gripping device 6, the biasing direction is held in the up and down and left and right directions to better stably hold the power tool. Therefore, for power tools that are provided with the outer housing mechanism of the present invention, when the operator performs close-range grinding/polishing, such as when working on an item at the horizontal plane or a nearly horizontal plane, one hand grips the control structure 10 to adjust the gear position of the tool or to start or stop the tool, holding it in the on position. By holding the housing 1011 on the outer end of a control structure 10, that is, the third gripping device 6 of the present embodiment, the other hand can grip the second gripping device 5 of the present embodiment to perform grinding and other work on surfaces, such as that of a car. Moreover, the second gripping device 5 is provided on the second housing component 102, precisely in the opposite direction of the third gripping device 6, which is also located at the lower section of the fourth gripping device 9. In this way, both hands can grip the tool for better stability. When performing long-range grinding, such as when working on an item at a substantially perpendicular angle to the horizontal plane, after turning on the control structure 10 and by gripping the housing 1011 of the control structure 10, that is, the third gripping device 6 of the present embodiment, the other hand can grip the first gripping device 4 of the present embodiment to perform grinding and other work. Moreover, the first gripping device 4 is provided on the first housing component and can be provided in a location near the third gripping device 6, such as on the housing 1011, a housing 1012, or a housing 1013 so that it is easy for the operator to apply force. Operation of the power tool is thus more labor-saving and the power tool can be gripped more stably. Correspondingly, work results are better; for example, the polished plane or curve will be flatter or smoother or the like.

According to an embodiment of the present invention, as shown in FIG. 23, the first housing component comprises the housing 1011, the housing 1012, and the housing 1013, wherein the housing 1011, the housing 1012, and the housing 1013 are sequentially connected, that is, one side of the housing 1012 is coupled to the housing 1011, and the other end is coupled to the housing 1013 to jointly form the first housing component and to encapsulate internal components such as the driving mechanism 200 and the output mechanism 300. The second housing component 102 of the present embodiment is coupled to the housing 1013 and disposed transversely with respect to the first housing component. The second housing assembly 102 is longitudinally disposed relative to the first housing component. This may be understood as a perpendicular or substantially perpendicular or nearly perpendicular provision. In the present embodiment, the control structure 10 is provided on the housing 1011, and the control structure 10 is used to switch the operating status of the power tool, that is, to turn the power tool on or off. The first gripping device 4 of the present embodiment may be provided on the housing 1011 or may be provided on the housing 1012 or may be provided on the housing 1013 or simultaneously provided on the housing 1011. The housing 1012, and the housing 1013, and the provision of which may be adapted as needed. When the first gripping device 4 is provided on the housing 1011, it is preferably provided on the side of the housing 1011 that is coupled to the housing 1012, that is, the side near the housing 1012. When the first gripping device 4 is provided on the housing 1012, it may be provided anywhere along the housing 1012 and may be provided singly or as a plurality. When first gripping device 4 is provided on the housing 1013 it may be provided anywhere along the housing 1012 and may be provided singly or as a plurality and may also be provided on the end of the housing 1013 that is coupled to the housing 1012, that is, the side near the housing 1012. In the present embodiment, a fourth gripping device 9 is provided on the outer free end of the housing 1013 that is provided precisely opposite to the third gripping device 6 provided on the housing 1011. When the tool is operated, one hand may grip the third gripping device 6, and the other hand may grip the fourth gripping device 9 to operate the tool. The first gripping device 4, second gripping device 5, third gripping device 6, and fourth gripping device 9 of the present embodiment may be combined and used according to the location of the work medium; for example, when performing fine grinding, the second gripping device 5 and third gripping device 6 may be gripped, wherein one hand holds the entire structure of the tool by gripping the third gripping device 6 and the other hand grips the second gripping device 5 to apply a force to the grinding component of the lower section of the second gripping device 5 to grind the surface of the workpiece. The force is applied to the second gripping device 5, that is, to the grinding component of the working component to better control the operation of the working component and thereby more finely grind the surface of a car, for example. When a certain angle is set at an angle to the horizontal plane, such as when the relative position is perpendicular to the operator, one hand can grip the overall structure of the tool by gripping the third gripping device 6, and the other hand can grip the first gripping device 4 to jointly support the power tool for good stability and better grinding results for when the working component, such as the grinding component, is used for grinding the surface of the workpiece. Similarly, when operated at the required working angle or range, the first gripping device 4, the second gripping device 5, the third gripping device 6, and the fourth gripping device 9 may be combined to stably grip the power tool when it is operated for better grinding results.

According to an embodiment of the present invention, as shown in FIG. 24, the first gripping device 4 of the present embodiment is preferably provided on the housing 1011 and/or the housing 1012 and/or the housing 1013 between the control structure 10 and the second housing component 102. In terms of the positional structure, the fourth gripping device 9 is provided, as shown in the figure, on the leftmost placement position of the power tool, that is, the position that consists of a section of the housing 1013. As shown in the figure, the direction is identified, wherein the third gripping device 6 is provided on the rightmost position of the power tool, that is, the position that consists of a section of the housing 1011. The first gripping device 4 is provided between the third gripping device 6 and the fourth gripping device 9, and the relative position is closer to the third gripping device 6. The second gripping device 5 of the present embodiment is provided on the second housing component 102, and in terms of the positional structure, the second gripping device 5 is located below the fourth gripping device 9. Similarly, the second gripping device 5 and the fourth gripping device 9 are both relatively provided at the free end of the power tool such that the space for gripping the second gripping device 5 and the fourth gripping device 9 is freer for more convenient operation, especially the location of the second gripping device 5 which makes gripping or releasing more convenient. The position of the second gripping device 5 is integrated, wherein the second gripping device 5 is provided on the left side of the first gripping device 4 of the present embodiment; on the right side, the control structure 10 and the third gripping device 6 of the present embodiment are provided, and the first gripping device 4 is provided on the housing 1011 and/or the housing 1012 and/or the housing 1013. In the present embodiment, the first gripping device 4 comprises a gripping section 41 and connecting section 42, wherein the gripping section 41 is adapted to the operator's fingers, in particular to the curvature of the operator's fingers. In this way, when the operator is using the tool, by gripping the gripping section 41 with fingers, it does not slip easily, such that operation of the tool is more stable. In the present embodiment, the gripping section 41 may be provided as a plurality of sections. In this way, when the operator uses the tool, the gripping section 41 is gripped by the fingers so that it does not slip easily, thereby making the operation of the tool more stable. In the present embodiment, the gripping section 41 may be provided as a plurality of sections so as to match the operator's gripping of the tool for work with a plurality of fingers. Because fingers have a certain arc or curvature, each gripping section 41 is similarly provided with different concave arcs or curvatures, that is, is formed with a relatively horizontal inwardly facing recess to facilitate the gripping of one or several fingers. Connecting sections 42 are used to connect adjacent gripping sections 41, and gripping sections 41 are smoothly connected by the connecting sections 42, preferably as an arced connection, wherein the corresponding horizontal surfaces of the connecting sections 42 are provided as protruding structures, that is, the corresponding horizontal surfaces are convexly formed, which are more applicable to the use of the gripping sections 41 of the present embodiment to facilitate the operator's gripping.

According to an embodiment of the present invention, based on the concave structure that the gripping section 41 included in the first gripping device 4 is provided as, a first anti-slip structure is also provided on the gripping section 41. Of course, the first anti-slip structure may fully cover the entirety of the gripping section 41 and connecting section 42 and may also fully cover the entirety of the first housing component, all of which are within the scope of the present embodiment. The provision of the first anti-slip structure is to prevent the operator's fingers from slipping during operation, that is, when the fingers are located at the gripping section 41 or are gripping onto the connecting section 42, friction is increased, further ensuring the stability of the held power tool. In the present embodiment, the first anti-slip structure is provided on the housing 1011 and/or the housing 1012 and/or the housing 1013 and covers the first gripping device 4. The first anti-slip structure may be provided as a bump or as a striped structure or as a bonded structure may be provided as a combination of these structures and are not limited to the scope of the present embodiment, all of which can be employed to prevent slipping.

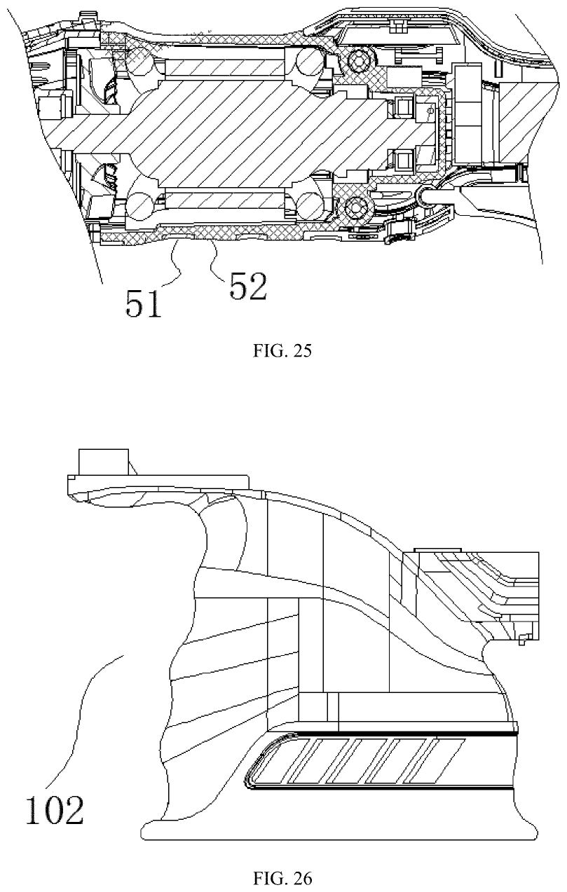

According to an embodiment of the present invention, as shown in FIG. 25, the second gripping device 5 of the present embodiment is preferably provided on the second housing component 102. As shown in the figure, from a positional perspective, it is located on a side of the second housing component 102 away from a side of the control structure 10, that is, on the outer side of the second housing component 102, which is correspondingly below the fourth gripping device 9. The external space of the second gripping device 5 is a free space and has no shielding parts to facilitate the operator's gripping and release to better facilitate the operator's application of force when using the tool and to adjust the required strength. In the present embodiment, the second gripping device 5 used for gripping is provided in a lateral direction, that is, it is substantially parallel to the direction of the first housing component. When the third gripping device 6 is used together with the second gripping device 5, one hand grips the power tool of the present embodiment from the upper section of the housing 1011 by gripping the third gripping device 6, and the biasing direction is to hold the third gripping device 6 from top to bottom with respect to the first housing component, that is, the biasing direction is from top to bottom, correspondingly, and is used on the housing 1011 of the power tool. The other hand grips the second housing component 102 from the left side of the second housing component 102 by gripping the second gripping device 5, and the biasing direction is to grip the second gripping device 5 from left to right with respect to the first housing component, that is, the direction of the force is relatively from left to right, and acts on the second housing component 102 of the power tool. By gripping the second gripping device 5 and third gripping device 6, the biasing direction is held in the up and down and left and right directions to better stably hold the power tool.

In the present embodiment, the second gripping device 5 comprises a gripping section 51 and a connecting section 52, wherein the gripping section 51 is adapted to the operator's fingers, in particular to the curvature of the operator's fingers. In this way, the gripping section 51 is gripped by the fingers so that it does not slip easily, thereby making operation of the tool more stable. In the present embodiment, the gripping section 51 may be provided as a plurality so as to match the operator's gripping of the tool for work with a plurality of fingers. Because fingers have a certain arc or curvature, each second gripping section 51 is similarly provided with different concave arcs or curvatures, that is, is formed with a relatively horizontal inwardly facing recess to facilitate the gripping of one or several fingers. The connecting section 52 is used to connect adjacent gripping sections 51, and gripping sections 51 are smoothly connected by the connecting sections 52, preferably as an arced connection, wherein the corresponding horizontal surfaces of the connecting sections 52 are provided as protruding structures, that is, the corresponding horizontal surfaces are convexly formed, which are more applicable to the use of the gripping section 51 of the present embodiment to facilitate the operator's gripping.

According to an embodiment of the present invention, on the basis that the gripping section 51 included in the second gripping device 5 is provided as a concave structure, a second anti-slip structure is provided on the gripping section 51. Of course, the second anti-slip structure may cover the entirety of the gripping section 51 and the connecting section 52 and may also fully cover the entirety of the first housing component, all of which are within the scope of the present embodiment. The second anti-slip structure is provided to prevent the slipping of the operator's fingers during operation, that is, when the fingers are located at the gripping section 51 or are gripping the connecting section 52, friction is increased to further ensure the stability of the held power tool. In the present embodiment, the second anti-slip structure is provided on the housing 1011 and/or the housing 1012 and/or the housing 1013 and covers the second gripping device 5. The second anti-slip structure may be provided as a bump or as a striped structure or as a bonded structure. These structures may also be combined and are not limited to the scope of the present embodiment. All may be employed to prevent slipping.

Finally, it should be noted that the above embodiments are only used to illustrate the technical solutions of the present invention, and are not limited thereto; although the present invention is described in detail with reference to the foregoing embodiments, those skilled in the art should understand that: the technical solutions described in the foregoing embodiments may be modified, or some of the technical features may be equivalently replaced; furthermore, such modifications or replacements do not cause the essence of the corresponding technical solutions to deviate from the scope of the technical solutions of the embodiments of the present invention.

In summary, the above description is only a preferred embodiment of the present invention, and all changes and modifications made to the scope of the present invention should be covered by the present invention.

1. A power tool for use with a rotatable work element, comprising:
a housing having a plurality of sidewall apertures, each sidewall aperture having a sidewall baffle to direct airflow from within the housing through the sidewall aperture to exterior of the housing;
a motor located within the housing and operable to generate a rotational drive force;
a rotatable work element drive member operatively connected to the motor to apply the rotational drive force to the work element drive member to produce rotation of the work element drive member about a work element drive member axis of rotation, the work element being attachable to the work element drive member for rotation therewith; and
a rotatable annular fan member located within the housing and operatively connected to the motor to apply the rotational drive force to the fan member to produce rotation of the fan member about a fan member axis of rotation, the fan member including a perimeter portion having a plurality of perimeter sections, each perimeter section including a fan blade and a fan member aperture adjacent to the fan blade, the fan blade being oriented to direct air from within the housing through the fan member aperture toward the housing sidewall apertures when the fan member is being rotated by the rotational drive force, the sidewall baffles directing the airflow exiting the sidewall apertures.

2. The power tool of claim 1, wherein the sidewall baffles direct the airflow exiting the sidewall apertures toward the work element when attached to the work element drive member.

3. The power tool of claim 1, further including an outer ring member extending about the perimeter sections, and wherein the fan blade of each perimeter section has an inward edge portion and an outward edge portion positioned radially outward of the inward edge portion, and the outward edge portion of each perimeter section is connected to the ring member.

4. The power tool of claim 3, further including a central support member located within the housing and operatively connected to the motor to apply the rotational drive force to the central support member, the central support member having an outer perimeter support wall portion, and wherein the inward edge portion of each perimeter section is connected to the outer perimeter support wall portion.

5. The power tool of claim 4, wherein the fan blades of adjacent ones of the perimeter sections, and the ring member and the outer perimeter support wall portion define an airflow guiding passageway therebetween, and wherein rotation of the fan member about a fan member axis of rotation directs air from within the housing downward through the airflow passageway prior to the air reaching the housing sidewall apertures.

6. The power tool of claim 3, wherein the outer edge portions of the fan blades of at least a portion of the perimeter section extend downward beyond the ring member.

7. The power tool of claim 1, wherein the fan blade of each perimeter section is oriented transverse to the fan member axis of rotation.

8. The power tool of claim 1, wherein the distance separating fan blades of adjacent perimeter section are equal.

9. The power tool of claim 1, wherein the housing has a downwardly opening lower end housing portion at which the work element is attachable to the work element drive member, and the sidewall apertures are located in the lower end housing portion.

10. The power tool of claim 1, wherein the plurality of perimeter sections extend fully about the fan member axis of rotation.

11. The power tool of claim 1, wherein the sidewall aperture is a slot oriented transverse to the fan member axis of rotation.

12. The power tool of claim 1, wherein the sidewall aperture has an inner opening and an outer opening, with the outer opening being larger than the inner opening.

13. The power tool of claim 12, wherein the sidewall aperture progressively increase in size between the inner opening and the outer opening.

14. The power tool of claim 12, wherein the inner opening of the sidewall aperture is a slot oriented transverse to the fan member axis of rotation.

15. A power tool for use with a rotatable work element, comprising:
a housing having a plurality of sidewall apertures, each sidewall aperture having a sidewall baffle to direct airflow from within the housing through the sidewall aperture to exterior of the housing;
a motor located within the housing and operable to generate a rotational drive force;
a rotatable work element drive member operatively connected to the motor to apply the rotational drive force to the work element drive member to produce rotation of the work element drive member about a work element drive member axis of rotation, the work element being attachable to the work element drive member for rotation therewith;
a central support member located within the housing and operatively connected to the motor to apply the rotational drive force to the central support member, the central support member having an outer perimeter support wall portion;
a rotatable annular fan member located within the housing and operatively connected to the motor to apply the rotational drive force to the fan member to produce rotation of the fan member about a fan member axis of rotation, the fan member including a perimeter portion having a plurality of perimeter sections, each perimeter section including a fan blade and a fan member aperture adjacent to the fan blade, the fan blade of each perimeter section having an inward edge portion connected to the outer perimeter support wall portion, the fan blade being oriented to direct air from within the housing through the fan member aperture toward the housing sidewall apertures when the fan member is being rotated by the rotational drive force, the sidewall baffles directing the airflow exiting the sidewall apertures;
an eccentric member mounted on the central support member for rotation therewith; and
a counterweight mounted on the central support member for rotation therewith.

16. The power tool of claim 15, further including a clamping member for retaining the eccentric member in position on the central support member during rotation of the central support member.

17. The power tool of claim 16, wherein the clamping member removably retains the eccentric member in position on the central support member.

18. The power tool of claim 16, further including a clamping member for retaining the counterweight in position on the central support member during rotation of the central support member.

19. The power tool of claim 18, wherein the clamping member removably retains the counterweight in position on the central support member.

20. The power tool of claim 15, further including a clamping member for retaining the counterweight in position on the central support member during rotation of the central support member.

21. The power tool of claim 19, wherein the clamping member removably retains the counterweight in position on the central support member.

22. The power tool of claim 15, wherein the counterweight and the eccentric member are attached together in position on the central support member during rotation of the central support member.

23. The power tool of claim 22, wherein the counterweight and eccentric member are attached together in position on the central support member during rotation of the central support member, at least in part by one of the counterweight and eccentric member having a recess, and the other of the counterweight and eccentric member having a protrusion sized and positioned to fit within the recess.

24. The power tool of claim 15, wherein the central support member has a central aperture sized to receive the eccentric member therein, and stop members positioned to retain the eccentric member within the central aperture during rotation of the central support member.

25. A power tool for use with a rotatable work element, comprising:
a housing having a plurality of sidewall apertures, each sidewall aperture having a sidewall baffle to direct airflow through the sidewall aperture between an interior of the housing and an exterior of the housing;
a motor located within the housing and operable to generate a rotational drive force;
a rotatable work element drive member operatively connected to the motor to apply the rotational drive force to the work element drive member to produce rotation of the work element drive member about a work element drive member axis of rotation, the work element being attachable to the work element drive member for rotation therewith; and
a rotatable annular fan member located within the housing and operatively connected to the motor to apply the rotational drive force to the fan member to produce rotation of the fan member about a fan member axis of rotation, the fan member including a perimeter portion having a plurality of perimeter sections, each perimeter section including a fan blade and a fan member aperture adjacent to the fan blade, when the fan member is rotated by the rotational drive force, air is forced through the fan member apertures, the fan blade being oriented such that the air passing through the fan member apertures creates an airflow between the interior of the housing and the exterior of the housing, the sidewall baffles directing the airflow passing through the sidewall apertures.

26. A power tool for use with a rotatable work element, comprising:
a housing having a plurality of sidewall apertures and an open housing end portion, each sidewall aperture having a sidewall baffle to direct airflow through the sidewall aperture;
a motor located within the housing and operable to generate a rotational drive force;
a rotatable work element drive member operatively connected to the motor to apply the rotational drive force to the work element drive member to produce rotation of the work element drive member about a work element drive member axis of rotation, the work element being attachable to the work element drive member at the open housing end portion for rotation with the work element drive member; and
a rotatable annular fan member located within the housing and operatively connected to the motor to apply the rotational drive force to the fan member to produce rotation of the fan member about a fan member axis of rotation, the fan member including a perimeter portion having a plurality of perimeter sections, each perimeter section including a fan blade and a fan member aperture adjacent to the fan blade, when the fan member is rotated by the rotational drive force, air is forced through the fan member apertures, the fan blade being oriented such that the air passing through the fan member apertures creates an airflow between the sidewall apertures and the open housing end portion, the sidewall baffles directing the airflow passing through the sidewall apertures.

27-36. (canceled)
